(19) United States
(12) Patent Application Publication
(10) Pub. No.: US 2026/0228972 A1
(43) Pub. Date: Aug. 6, 2026

(54) System and Method for Dynamic Monitoring of Spatio-Temporal Environmental Processes Using Mobile Sensing Agents and Adaptive Data Assimilation

(71) Applicant: Mitsubishi Electric Research Laboratories, Inc., Cambridge, MA (US)

(72) Inventors: Vedang Mohanrao Deshpande, Attleboro, MA (US); Abraham Puthuvana Vinod, Braintree, MA (US)

(73) Assignee: Mitsubishi Electric Research Laboratories, Inc., Cambridge, MA (US)

(21) Appl. No.: 19/043,643

(22) Filed: Feb. 3, 2025

(51) Int. Cl. G06T 17/05; B64U 10/14; B64U 101/31

(52) U.S. Cl. CPC G06T 17/05; B64U 10/14; B64U 2101/31; B64U 2201/10

(57) ABSTRACT

A system for dynamic monitoring of spatio-temporal environmental processes, such as bio-mass growth in water bodies, utilizes a plurality of mobile sensing agents equipped with environmental sensors to collect data. The system includes a processor and memory storing instructions that, when executed, implement a spatio-temporal model to predict the state of bio-mass growth and quantify associated uncertainties. A scheduling algorithm optimizes the selection of sensing locations and assigns the mobile sensing agents to those locations by considering the state of the bio-mass growth, associated uncertainties, operational constraints, and the agents' reachability. The system updates the model's states and parameters based on the collected data and iteratively refines subsequent sensing location selections and agent assignments.

### TECHNICAL FIELD

The present disclosure relates to systems and methods for monitoring spatio-temporal environmental processes, particularly in water bodies. More specifically, the disclosure pertains to a system utilizing mobile sensing agents and adaptive data assimilation techniques to estimate the environmental variables and refine parameters of dynamic models representing bio-mass growth and similar environmental phenomena.

### BACKGROUND

Environmental monitoring plays a vital role in understanding and managing natural systems, particularly those that exhibit dynamic behaviors over time and space. Many environmental processes, such as changes in bio-mass growth, nutrient levels, or pollution dispersion, are inherently complex and influenced by numerous interdependent factors, including climatic conditions, hydrodynamics, and human activities. Capturing these dynamic and interconnected processes is essential for informed decision-making and effective resource management.

Traditional environmental monitoring systems often rely on static or pre-defined sensing frameworks. These methods typically deploy fixed sensors or conduct periodic manual sampling at designated locations. While these approaches provide valuable data, they are limited in their ability to capture the temporal and spatial variability of dynamic systems. Static monitoring fails to adapt to changing environmental conditions, such as sudden shifts in nutrient levels, temperature fluctuations, or the emergence of localized phenomena like algal blooms. Consequently, these systems may miss critical changes or provide incomplete data, reducing their effectiveness in addressing environmental challenges.

In addition to their lack of adaptability, static monitoring systems face practical challenges. Monitoring large or remote areas can be logistically difficult and resource-intensive, particularly in water bodies or other hard-to-reach environments. Fixed sensors often lack the coverage needed to represent the spatial heterogeneity of the monitored system adequately. Furthermore, the operational costs of deploying and maintaining static infrastructure can be prohibitive, particularly when attempting to monitor large-scale environmental systems comprehensively.

Another limitation of static monitoring systems is their inefficiency in balancing data collection efforts with the specific needs of the monitored system. For instance, in dynamic environments, certain regions may require more frequent sampling due to high variability, while others may remain stable and require less attention. Static systems cannot dynamically allocate resources to prioritize data collection in regions of interest, leading to inefficient use of monitoring resources.

Overall, the limitations of static environmental monitoring highlight the need for adaptive approaches capable of responding to the dynamic nature of environmental processes. Addressing these challenges requires systems that can provide greater spatial and temporal coverage, efficiently allocate resources, and adapt in real-time to changes in monitored conditions.

### SUMMARY

Environmental monitoring of spatio-temporal processes, such as bio-mass growth in water bodies, is complicated by the dynamic nature of these systems. Factors like nutrient levels, temperature, sunlight, and water currents interact to create intricate and ever-evolving patterns that cannot be effectively captured using static monitoring approaches. Traditional methods, which rely on fixed sensors or manual sampling, fail to adapt to these dynamic changes, leading to incomplete data collection and limited predictive accuracy. Moreover, the vastness and inaccessibility of many water bodies introduce logistical challenges, making static monitoring both inefficient and impractical for large-scale applications.

To address these limitations, a solution presented in this disclosure integrates mobile sensing agents, spatio-temporal models, and adaptive scheduling algorithms into a unified system for dynamic environmental monitoring. The system employs mobile sensing agents, such as aerial drones, equipped with sensors to collect environmental data. A spatio-temporal model is used to represent the dynamic behaviors of environmental processes, such as bio-mass growth, by estimating states defined by environmental variables and updating the model parameters based on collected data. A scheduling algorithm is configured to jointly select sensing locations and assign mobile sensing agents to these locations, optimizing an objective function based on model states and parameters, while adhering to operational constraints and reachability limitations.

The technical effect of this integrated approach lies in its ability to dynamically adapt to changing environmental conditions. The system leverages real-time data assimilation to continuously refine the spatio-temporal model, ensuring it remains aligned with observed behaviors. By optimizing the scheduling of mobile sensing agents, the system reduces uncertainty in model estimates, minimizes travel costs, and ensures feasibility under operational constraints. This iterative feedback loop allows the system to focus monitoring efforts on regions of high variability or uncertainty, improving the accuracy and efficiency of data collection.

From a business perspective, the described system offers significant benefits. The use of mobile sensing agents reduces the need for extensive fixed infrastructure, lowering deployment and maintenance costs. By efficiently targeting data collection efforts, the system minimizes operational expenditures while maximizing the informativeness of the collected data. This targeted, adaptive approach enhances decision-making capabilities for applications such as resource management, pollution control, and ecosystem monitoring. Furthermore, the scalability and adaptability of the system make it suitable for diverse environmental settings, broadening its applicability across industries and use cases.

In effect, the system's technical and business benefits demonstrate its potential to transform spatio-temporal environmental monitoring by enabling more efficient, accurate, and cost-effective approaches to understanding and managing complex natural systems.

Accordingly, one embodiment discloses a system for dynamic monitoring of spatio-temporal environmental processes describing bio-mass growth in water bodies using a plurality of mobile sensing agents equipped with sensors for collecting environmental data, the system comprising: a processor; and a memory having instructions stored thereon that, when executed by the processor, cause the system to: implement a spatio-temporal model representing dynamic behaviors of the environmental processes based on parameters of the spatio-temporal model to predict a state of the bio-mass growth in water bodies defined by environmental variables, and the associated uncertainty; execute a scheduling algorithm configured to select sensing locations for the mobile sensing agents and assign the mobile sensing agents to the selected sensing locations by optimizing an objective function of the state of the bio-mass growth and the associated uncertainty subject to operational constraints and reachability limitations of the mobile sensing agents; update the states and parameters of the spatio-temporal model based on the environmental data collected by the mobile sensing agents at the sensing locations; and generate subsequent sensing location selections and agent assignments using the updated spatio-temporal model.

Another embodiment discloses a method for dynamic monitoring of spatio-temporal environmental processes describing bio-mass growth in water bodies using a plurality of mobile sensing agents equipped with sensors for collecting environmental data, wherein the method uses a processor coupled with stored instructions implementing the method, wherein the instructions, when executed by the processor carry out steps of the method, comprising: implementing a spatio-temporal model representing dynamic behaviors of the environmental processes based on parameters of the spatio-temporal model to predict a state of the bio-mass growth in water bodies defined by environmental variables, and the associated uncertainty; executing a scheduling algorithm configured to select sensing locations for the mobile sensing agents and assign the mobile sensing agents to the selected sensing locations by optimizing an objective function of the state of the bio-mass growth and the associated uncertainty subject to operational constraints and reachability limitations of the mobile sensing agents; updating the states and parameters of the spatio-temporal model based on the environmental data collected by the mobile sensing agents at the sensing locations; and generating subsequent sensing location selections and agent assignments using the updated spatio-temporal model.

### BRIEF DESCRIPTION OF THE DRAWINGS

FIG. 1 illustrates a schematic representation of a system for dynamic monitoring of spatio-temporal environmental processes, employing mobile sensing agents and adaptive data assimilation.

FIG. 2 depicts a control system implemented on a base station for controlling a fleet of unmanned aerial vehicles (UAVs) to monitor environmental processes in water bodies.

FIG. 3A shows an exemplar UAV equipped with a payload for carrying specialized sensing equipment for environmental monitoring tasks.

FIG. 3B depicts a UAV with onboard sensors and guidance systems for monitoring spatio-temporal processes.

FIG. 4 illustrates a block diagram of the system's components, integrating a spatio-temporal model, scheduling algorithm, data assimilation processes, and feedback mechanisms.

FIG. 5 demonstrates a reaction-diffusion framework for modeling bio-mass growth dynamics in water bodies, including logistic growth, diffusion, and external forcing terms.

FIG. 6 outlines a greedy algorithm used by the scheduling process to optimize sensing location selections and mobile sensing agent assignments.

FIG. 7 depicts the system's optimization of an objective function, prioritizing uncertainty reduction in state estimates to enhance environmental monitoring.

FIG. 8 shows an iterative parameter update process using data assimilation techniques to refine growth rates, diffusion coefficients, and nutrient uptake rates in the spatio-temporal model.

FIG. 9 highlights the integration of reachability constraints into the scheduling algorithm, ensuring feasible assignments for mobile sensing agents.

FIG. 10 presents a weighted optimization framework balancing uncertainty reduction, travel costs, and feasibility constraints in the monitoring process.

FIG. 11 illustrates a heuristic-driven approach for prioritizing sensing locations and assignments for mobile sensing agents.

FIG. 12 details how the scheduling algorithm ensures conflict-free, efficient deployment of sensing agents by avoiding duplicate assignments.

FIG. 13 incorporates external factors like temperature, nutrient availability, and water currents into the spatio-temporal model using external forcing terms.

FIG. 14 demonstrates the use of an Extended Kalman Filter for updating states and parameters in the spatio-temporal model using linearized non-linear dynamics.

FIGS. 15A, 15B, and 15C show pseudo-codes of different algorithms used by various embodiments.

### DETAILED DESCRIPTION

### Overview of Contribution to the Art

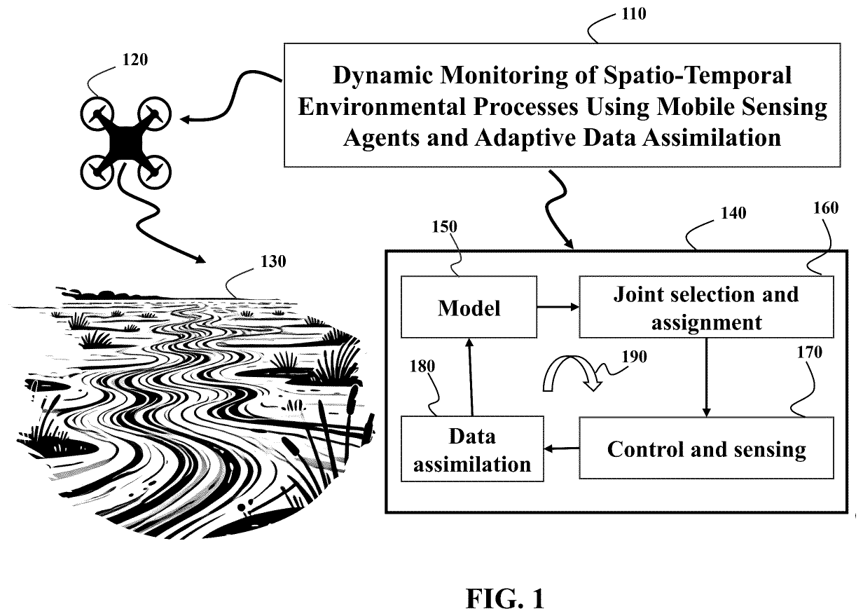

FIG. 1 illustrates a schematic representation of a system and method for dynamic monitoring of spatio-temporal environmental processes, employing mobile sensing agents and adaptive data assimilation, in accordance with some embodiments. The system 110 leverages mobile sensing agents, such as aerial drones 120 or similar sensor-equipped devices, to monitor a water body 130 effectively. This approach addresses the dynamic nature of environmental processes, such as bio-mass growth, which vary over both spatial and temporal domains.

The system 110 employs an iterative feedback mechanism 140 to facilitate adaptive monitoring. This feedback mechanism integrates a spatio-temporal model 150 that represents the dynamic behaviors of the monitored environmental process. The model provides a structured framework to estimate states, such as bio-mass density or nutrient levels, and update parameters based on the collected data.

The system is configured to perform 160 the joint selection of sensing locations and assignment of mobile sensing agents. This step involves optimizing an objective function to determine sensing locations and assign agents to the selected locations in a way that satisfies various operational constraints. These constraints may include reachability constraints, energy consumption, and resource limitations. These constraints together ensure that the sensing tasks are both feasible and practical.

Once the schedule of sensing locations and assignments is generated, the system controls 170 mobile sensing agents to execute the monitoring task. The drones 120 or other sensing agents are directed to their assigned locations to collect environmental data from the water body 130. This data includes measurements such as bio-mass density, nutrient concentrations, and other relevant variables.

The collected data is then used to improve 180 the accuracy of the spatio-temporal model. The data assimilation process refines the estimated states such as bio-mass densities and updates the model parameters, such as growth rates, diffusion coefficients, or environmental forcing terms, enhancing the model's predictive capability. By updating the model with real-world observations, the system ensures that subsequent predictions align closely with the evolving conditions of the monitored environment.

Next, this process completes the feedback loop 190, where the improved model directly informs the next cycle of sensing location selection and agent assignment. This iterative approach ensures continuous improvement in monitoring accuracy, efficiency, and adaptability. By dynamically adjusting to changes in environmental conditions and optimizing the deployment of sensing agents, the system achieves effective and resource-efficient monitoring of spatio-temporal processes in water bodies. In effect, this schematic demonstrates the integration of mobile sensing, model-based estimation, and adaptive data assimilation to address the challenges of dynamic environmental monitoring in a scalable and flexible manner.

Understanding the challenges of environmental monitoring begins with recognizing the dynamic nature of spatio-temporal processes, such as bio-mass growth in water bodies. These processes evolve over both space and time. Bio-mass density, for example, can fluctuate due to several factors like nutrient availability, temperature, sunlight, and water currents. These interdependent factors create intricate and ever-changing patterns, making it essential to devise effective strategies that can adapt to this variability.

Some embodiments use spatio-temporal models such as differential equations or state-space representations to describe and predict these dynamical behaviors. These models link key states of the system, like bio-mass densities at different locations, to external influences, such as nutrient levels, and inherent processes, like diffusion. For instance, nutrient influx may locally increase bio-mass density, while diffusion causes the bio-mass to spread across adjacent regions. By integrating growth and dispersion mechanisms, such models offer a structured framework for understanding environmental changes.

In different embodiments, the state of the system includes variables such as bio-mass density, nutrient concentrations, oxygen levels, and temperature profiles at different locations within the water body. These states capture the spatially distributed and temporal characteristics of bio-mass growth. Additionally, model parameters, including growth rates, nutrient uptake rates, and diffusion coefficients, define the system's behavior under varying conditions. For example, the carrying capacity of an environment represents the maximum bio-mass density it can sustain, while the diffusion coefficient indicates how bio-mass spreads spatially.

Unfortunately, any model configured to describe spatio-temporal dynamics of a state of bio-mass growth in water bodies is affected by uncertainties due to its uncertain parameters. Variations in water quality, weather conditions, and measurement noise introduce randomness, making the estimation of model parameters difficult. Continuous adaptation of the model becomes essential as new measurements allow for iterative refinement. Adjustments to parameters, such as growth rates in areas where bio-mass expansion is slower than anticipated, help maintain alignment with the environment's current behavior and improve predictive accuracy.

This iterative process relies on a feedback mechanism where data collected by mobile sensing agents refines the model and state estimates, which then guides subsequent data collection. For example, regions with higher uncertainty in bio-mass density may be prioritized, allowing the model to update its parameters and refine its predictions. This continuous exchange of data and predictions enhances both the model and the overall monitoring strategy.

In practice, monitoring bio-mass growth over large water bodies presents logistical challenges. Direct measurements across vast or remote regions may be impractical. Mobile sensing agents, such as aerial drones, can address this issue by collecting targeted environmental data. However, determining when and where these agents should collect data introduces complexities, including the need to manage reachability constraints and minimize travel costs. Scheduling methods have been developed to tackle this, simultaneously identifying optimal sensing locations and assigning agents in a manner that balances considerations such as travel efficiency, measurement informativeness, and the reliability of model updates.

The scheduling process described in various embodiments is informed by the selection of objective functions and optimization methods, which guide how agents are deployed to collect data effectively and efficiently. Objective functions are configured to address different aspects of the monitoring process, depending on the needs of a given implementation.

Some embodiments may prioritize reducing uncertainty in model estimates by focusing on minimizing the log-determinant of the posterior covariance matrix. This approach is intended to enhance confidence in state and parameter estimates, leading to more dependable predictions. Other embodiments might emphasize minimizing travel costs, aiming to make efficient use of agent resources by reducing the distances agents travel between sensing locations. Certain implementations may focus on maximizing information gain by directing agents to sensing locations that are anticipated to provide the most meaningful data, often measured using mutual information or entropy reduction metrics. In some configurations, the scheduling process balances multiple objectives, integrating considerations such as uncertainty reduction and travel cost optimization through weighted combinations. Additionally, embodiments may ensure that dynamic feasibility is maintained, making certain that the team of agents can reach the selected sensing locations under given constraints.

The embodiments may employ various optimization methods to implement these objectives, each offering potential advantages depending on the specific combination of objectives and constraints. For example, in some embodiments, greedy optimization is utilized to iteratively select actions that provide immediate benefits, such as reducing uncertainty or travel costs. This method is computationally efficient and straightforward to implement, making it suitable for certain applications. However, it may not always identify globally optimal solutions for more complex scenarios.

Other embodiments may use dynamic programming (DP), which organizes the scheduling problem into smaller subproblems, solving them recursively to determine an optimal solution. This approach is often beneficial for sequential decision-making. At the same time, DP can become computationally intensive for larger systems, depending on the complexity of the problem.

In certain configurations, mixed-integer linear programming (MILP) may be applied to precisely model constraints and objectives. MILP has the potential to deliver globally optimal solutions for systems with finite problem sizes and is particularly useful in addressing complex constraints. However, computational demands may grow for systems with a high dimensionality, which can influence their suitability for specific embodiments.

Some embodiments may incorporate reinforcement learning (RL), which allows agents to learn scheduling policies through interaction with the environment. RL may adapt effectively to dynamic and non-linear conditions and can accommodate complex reward structures. However, implementations utilizing RL may require significant training and computational resources, and outcomes may vary based on system configurations.

The described embodiments encompass different combinations of objective functions and optimization methods, allowing for flexibility in tailoring the scheduling process to various monitoring needs. Each implementation seeks to address the unique characteristics of spatio-temporal monitoring, making it possible to adapt to different constraints and data collection requirements while maintaining the intended functionality. These embodiments are not limited to any specific combination of objectives or optimization techniques, providing protection for a wide range of potential configurations.

Some embodiments are based on the recognition of the advantages of jointly performing the selection of sensing locations and the assignment of mobile sensing agents to those locations for optimizing the monitoring of biomass growth in dynamic environments. By integrating these two tasks into a unified scheduling algorithm, the system can achieve greater efficiency, adaptability, and accuracy in collecting data while considering the operational constraints and reachability limitations of the agents.

When the sensing locations and agent assignments are determined separately, there is a risk of suboptimal results due to a lack of coordination between the tasks. For example, sensing locations might be chosen without accounting for the specific capabilities or current positions of the mobile sensing agents, leading to increased travel times, inefficient use of resources, or even infeasibility due to dynamic constraints such as battery life or terrain limitations. Similarly, assigning agents to pre-determined locations without considering the spatial distribution and informativeness of those locations may result in data collection efforts that fail to adequately refine the model or reduce uncertainty in the state of the bio-mass growth.

By jointly optimizing the selection of sensing locations and the assignment of mobile sensing agents, the embodiments can take a holistic approach to the problem. It can evaluate the trade-offs between maximizing the informativeness of the collected data and minimizing the associated costs, such as travel distance or time. For instance, the algorithm may prioritize sensing locations that are both highly informative for updating the model and reachable by the agents with minimal energy expenditure or time delay. This joint approach allows the system to allocate resources more effectively, ensuring that each mobile sensing agent contributes meaningfully to the overall monitoring strategy.

Furthermore, the joint optimization can explicitly account for reachability constraints, such as changes in environmental conditions, agent mobility, or operational limits. For example, the algorithm can dynamically adjust assignments to avoid unreachable locations or reallocate agents to alternative sites that offer comparable benefits. This adaptability is crucial in spatio-temporal monitoring scenarios where conditions can change rapidly, and pre-determined schedules may quickly become outdated or infeasible.

Additionally, optimizing the selection and assignment tasks together enables the algorithm to leverage feedback from the spatio-temporal model itself. By integrating an objective function based on the state of the bio-mass growth model, the algorithm can focus on reducing uncertainty or improving model accuracy in areas where it is most needed. This alignment between the scheduling process and the system's broader goals ensures that the monitoring efforts are strategically targeted, maximizing the value of the collected data and enhancing the system's overall performance.

In effect, jointly performing the selection of sensing locations and the assignment of mobile sensing agents allows for a coordinated and adaptive approach to environmental monitoring. By optimizing an objective function that reflects the quality or usefulness of measurements while adhering to operational constraints and reachability limitations, the system can achieve efficient and effective data collection, ultimately improving the accuracy and utility of the spatio-temporal model.

In monitoring spatio-temporal environmental processes, updating the parameters of a dynamic model can enhance the system's alignment with observed behaviors, such as bio-mass growth. Parameters such as the growth rate coefficient and the diffusion coefficient may be used in various embodiments to describe environmental dynamics. The growth rate coefficient relates to how bio-mass increases under certain conditions, while the diffusion coefficient represents the spatial spread of bio-mass due to factors like water currents or mixing. Regularly updating these parameters allows the model to better reflect changing environmental conditions and improve its predictions.

Several data assimilation methods can be implemented in different embodiments to update these parameters. For instance, batch optimization techniques may process data collectively, using a cost function to adjust parameters based on discrepancies between observed and predicted states. Other approaches, such as particle filters, may represent distributions of possible parameter values, iteratively refining these distributions as more data is collected. These methods provide options for accommodating various system requirements and scenarios.

In certain embodiments, the Extended Kalman Filter (EKF) may offer advantages for updating parameters in conjunction with estimating the states. EKF is a model-based estimation method which combines model predictions with the sensor data to estimate variables of interest, such as model states and parameters. The EKF operates in real-time, making it suitable for systems where environmental conditions evolve continuously. The EKF involves linearization of the non-linear model around its current state estimates, and it efficiently integrates new measurements to adjust both the states and the parameters of the model. This allows parameters such as the growth rate and diffusion coefficients to be refined as new environmental data is collected.

The EKF also accounts for uncertainties in both the process model and the measurements, which may vary in different implementations. It does so by weighting states and parameters updates using covariance matrices that represent the reliability of the data and the model predictions, thus, ensuring that states and parameters adjustments are less influenced by noisier measurement data.

In embodiments where computational efficiency is prioritized, the EKF may be particularly advantageous because it updates parameters incrementally with each new data point, avoiding the need to reprocess large datasets as required by batch methods. Additionally, its iterative nature supports adaptability in real-time, which may be valuable in scenarios where environmental conditions change frequently, such as fluctuating nutrient levels or variations in water currents.

While different embodiments may utilize alternative data assimilation methods depending on specific requirements or constraints, the EKF offers a balanced approach for certain implementations. By combining efficiency, adaptability, and robust handling of uncertainties, the EKF can enhance the performance of systems designed to monitor and predict bio-mass growth through continuous state and parameter updates.

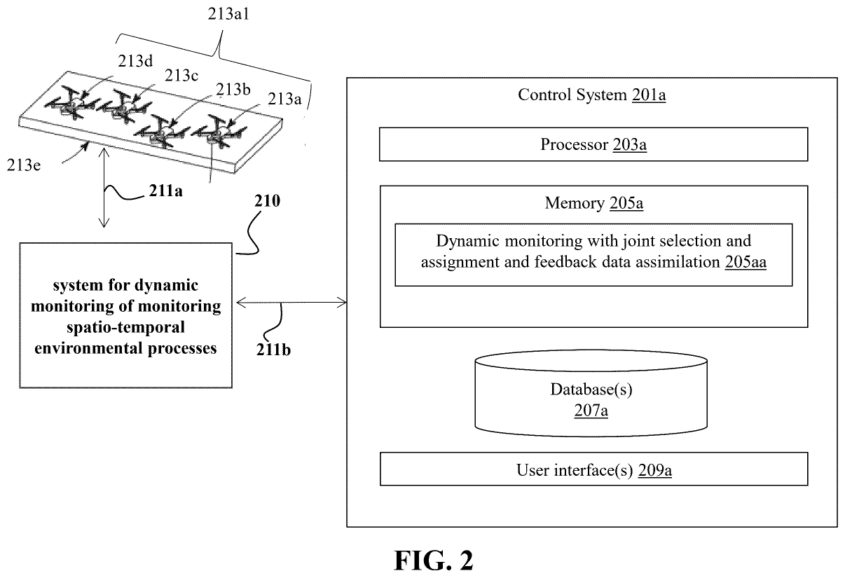

FIG. 2 shows a schematic of a control system 201a implemented on a base station 210 for controlling a fleet of Unmanned Aerial Vehicles (UAVs), in accordance with an example embodiment. As shown in FIG. 2, the control system 201a is communicatively coupled to a fleet of UAVs 213a1 via a communication network 211a. The fleet of UAVs 213a1 includes a plurality of drones, i.e., a UAV 213a, a UAV 213b, a UAV 213c, and a UAV 213d. The fleet of UAVs 213a1 may be stationed at platform 213e. The system 201a includes a processor 203a and a memory 205a. The system 210a can also include or be connected to a database 207a, and a user interface 209a. Memory 205a includes stored instructions 205aa implementing the joined control method. The processor 203a is coupled with the stored instructions implementing the method, wherein the instructions, when executed by the processor carry out steps of the joined control method.

Various components of the control system 201a may be coupled directly or indirectly to the communication network 211a. The communication network 211a may be wired, wireless, or any combination of wired and wireless communication networks, such as cellular, Wi-Fi, internet, local area networks, or the like. In some embodiments, the communication network 211a may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, International Mobile Telecommunications (ITU-IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. The components of the control system 201a may be further broken down into more than one component and/or combined together in any suitable arrangement. Further, one or more components may be rearranged, changed, added, and/or removed.

The system 201a includes suitable logic, circuitry, and interfaces that may be configured to control the one or more UAVs of the fleet of UAVs 213al to perform the one or more missions efficiently. In some embodiments, the fleet of UAVs 213al may be stationed at the initial terminal or platform 213e. Further, at least one of the UAV 213a, the UAV 213b, the UAV 213c, and the UAV 213d may be used to perform the one or more missions efficiently. In some embodiments, the system 201a may be embodied as a chip or chip set. In other words, the system 201a may comprise one or more physical packages (such as chips) that includes materials, components and/or wires on a structural assembly (such as, a baseboard).

The memory 205a of the system 201a may include one or more modules related to, but not limited to, geocoding, routing (multimodal, intermodal, and unimodal), clustering algorithms, machine learning in location-based solutions, natural language processing algorithms, and artificial intelligence algorithms. Data for one or more modules of the memory 205a may be collected using a plurality of technologies including, but not limited to drones, sensors, connected cars, cameras, interfaces, probes, and chipsets.

In some embodiments, memory 205a may be non-transitory and may include, for example, one or more volatile and/or non-volatile memories. In other words, for example, the memory 205a may be an electronic storage device (for example, a computer-readable storage medium) comprising gates configured to store data (for example, bits) that may be retrievable by a machine (for example, a computing device like the processor 203a). The Memory 205a may be configured to store information, data, content, applications, instructions, or the like, to enable the apparatus to carry out various functions in accordance with an example embodiment of the present disclosure. For example, the memory 205a may be configured to buffer input data for processing by the processor 203a. The memory 205a may be configured to store instructions for execution by the processor 203a. As such, whether configured by hardware or software methods, or by a combination thereof, the processor 203a may represent an entity (for example, physically embodied in circuitry) capable of performing operations according to an embodiment of the present disclosure while configured accordingly. Thus, for example, when processor 203a is embodied as an ASIC, FPGA, or the like, the processor 203a may be specifically configured hardware for conducting the operations described herein. Alternatively, as another example, when processor 203a is embodied as an executor of software instructions, the instructions may specifically configure processor 203a to perform the algorithms and/or operations described herein when the instructions are executed. However, in some cases, the processor 203a may be a processor-specific device (for example, a mobile terminal or a fixed computing device) configured to employ an embodiment of the present disclosure by further configuration of the processor 203a by instructions for performing the algorithms and/or operations described herein. The Processor 203a may include, among other things, a clock, an arithmetic logic unit (ALU), and logic gates configured to support the operation of the processor 203a.

In some embodiments, system 201a includes processor 203a for conducting processing functions associated with system 201a and database 207a for storing and retrieving data. In an embodiment, system 201a may comprise one or more processors configured to process requests received from system 201a. Further, in some embodiments, the database 207a comprises suitable logic, circuitry, and interfaces that may be configured to store the data associated with one or more participants of one or more missions.

In some embodiments, the one or more UAVs of the fleet of UAVs 213a1 include one or more sensors, user equipment, and/or a communication interface (not shown in FIG. 2). Additional, fewer, or different components may be provided. For example, a proxy server, a name server, a map server, a cache server or cache network, a router, a switch or intelligent switch, an additional database, additional computers or workstations, administrative components, such as an administrative workstation, a gateway device, a backbone, ports, network connections, and network interfaces may be provided. While the components in FIG. 2 are shown as separate from one another, one or more of these components may be combined. In this regard, system 201a may be communicatively coupled to the components shown in FIG. 2 to carry out the desired operations and wherever required modifications may be possible within the scope of the present disclosure.

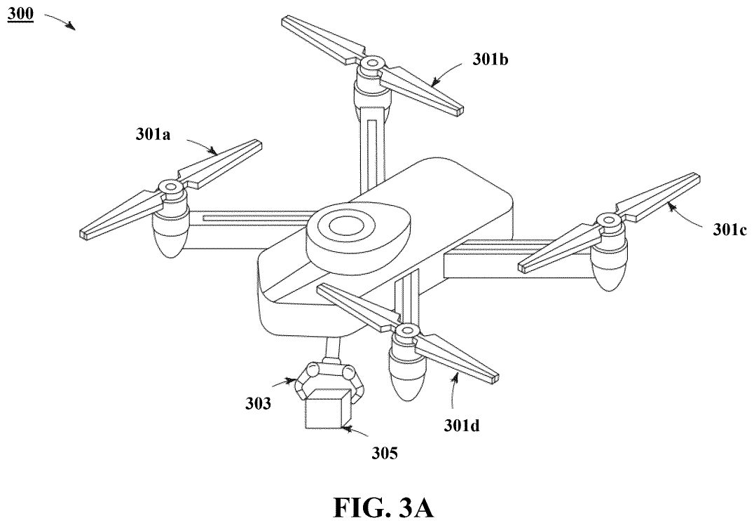

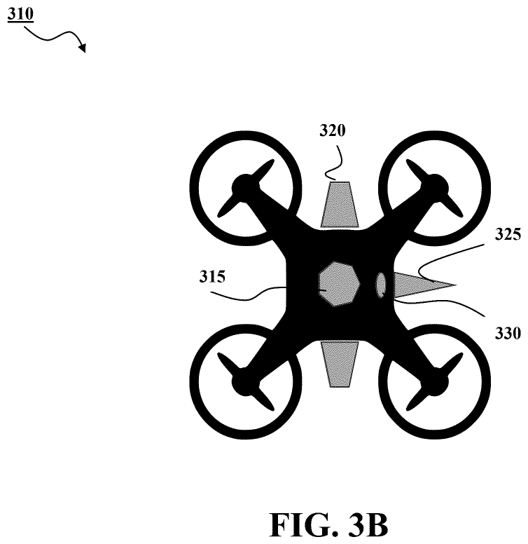

FIGS. 3A-3B show schematics of exemplar implementations of UAV 300 and UAV 310 used for performing different tasks, such as delivery services and monitoring tasks, in accordance with different embodiments. The UAV 300 corresponds to one of UAVs of the fleet of UAVs 213al, e.g., the UAV 213a. As shown in FIG. 3A, the UAV 300 comprises a rotor blade 301a, a rotor blade 301b, a rotor blade 301c, a rotor blade 301d, and a mechanical claw 303 for carrying a specialized sensing equipment 305.

As shown in FIG. 3B, in various implementations the UAV is equipped with sensors for performing monitoring tasks. For example, the UAV 310 maybe equipped with localization and flying sensors, monitoring sensors 320, 325, and/or guidance system 330.

Referring back to FIG. 3A, in some embodiments, the UAV 300 may be a single-rotor UAV that comprises a single rotor blade. In some embodiments, the UAV 300 may be a Tri copter that comprises three rotor blades. In some embodiments, the UAV 300 is a quadcopter that comprises four rotor blades. In some embodiments, the UAV 300 is a hex copter that comprises six rotor blades. In some embodiments, the UAV 300 is an octocopter that comprises eight rotor blades. In some embodiments, the UAV 300 having more than one rotor blade may be referred to as multi-rotor UAV. Further, in some embodiments, the UAV 300 is a fixed-wing UAV that comprises a fixed wing. In some embodiments, the UAV 300 is a fixed-wing hybrid vertical take-off landing (VTOL) UAV that is a hybrid of the fixed-wing UAV and VTOL aircrafts. In some embodiments, the one or more rotors may be referred to as “one or more propellers”.

Further, the UAV 300 may include one or more means for carrying the package 305. One or more means include, but are not limited to, a vacuum mechanism, magnetic mechanism, electro-magnetic mechanism, or suction cup fastening mechanism.

In some embodiments, the UAV 300 may comprise a rotor assembly (not shown) to generate lift and thrust. The rotor assembly includes, but is not limited to a rotor hub, a rotor blade, a drive system, a fuselage, and a payload module. In some embodiments, the rotor hub is mounted on the central axis of the fuselage, allowing for rotation around the central axis of the fuselage. The rotor blade is attached to the rotor hub. Further, the rotor blade is rotated to generate the lift and thrust. The drive system is integrated into a power source to impart rotational motion to the rotor blade, enabling the flight operation of the exemplary UAV 300.

In some embodiments, the fuselage is a rigid structure that comprises one or more components for enabling the flight operation of the UAV 300. One or more components include, but are not limited to, the power source, and a flight control system. The power source is used to provide power to the rotor assembly. In one embodiment, the power source is an electric motor. Further, in some embodiments, the power source is a combustion engine. In some embodiments, the flight control system is used to maintain the stability of the UAV 300. In some embodiments, the flight control system is used for controlling one or more flight parameters. Further, in some embodiments, the flight control system is used to receive and process input commands. The payload module enables the attachment and transportation of one or more payloads. In one embodiment, the payload module is positioned beneath the rotor assembly. In one embodiment, the payload module is centrally located within the fuselage. In one embodiment, the payload module is integrated into a separate compartment. The payload module includes, but is not limited to cameras, sensors, and delivery mechanisms.

In some embodiments, a variable-pitch mechanism is incorporated in the UAV 300. The variable pitch mechanism allows for dynamic adjustment of the rotor blade's angle during flight. The variable-pitch mechanism enables precise control over the lift and thrust generation. The variable-pitch mechanism provides maneuverability, stability, and responsiveness in bad weather conditions such as snowstorm, heavy rainfall and the like. In some embodiments, the variable-pitch mechanism is used to perform complex flight maneuvers.

In some embodiments, a gyroscopic stabilization mechanism is incorporated in the UAV 300. The gyroscopic stabilization mechanism provides stability and counteracts a torque generated by rotation of the rotor blade. The gyroscopic stabilization mechanism comprises one or more sensors. The one or more sensors are used to detect and measure an angular movement of the UAV 300. Based on the measured angular mechanism, the flight control system adjusts a rotation speed of rotor blade and a blade pitch of rotor blade for maintaining balance during the flight.

In some embodiments, a swashplate mechanism is integrated into the UAV 300. The swashplate mechanism allows for cyclic control the pitch of rotor blade at one or more points along a length of rotor blade. By adjusting the pitch of the blade pitch cyclically, the UAV 300 achieves movement in one or more directions such as forward, backward, sideways, rotation, and the like.

In some embodiments, one or more avionics systems are incorporated in the UAV 300 for controlling and monitoring the flight. The one or more avionics systems comprise one or more sensors, one or more onboard processors, and a communication module. The one or more avionics systems collect data from the one or more sensors such as GPS, altimeters, gyroscopes, accelerometers, and magnetometers, multispectral sensors, thermal sensors to determine an exemplary UAV position, an exemplary UAV altitude, an exemplary UAV orientation and the like. The one or more avionics systems process the collected data to adjust the one or more control surfaces.

In some embodiments, a communication module facilitates communication between the UAV 300 and a ground control station (GCS). The communication module enables a real-time data transmission, a telemetry monitoring, a control signal exchange, and the like between the UAV 300 and a drone operator. In some embodiments, the communication module employs one or more wireless technologies such as a radio frequency (RF), a satellite communication, one or more cellular networks, and the like to communicate with the GCS.

In some embodiments, the assignment determined by the system 201a for the UAV of the fleet of UAVs 213al for the mission is transmitted to a controller associated with the UAV. The controller of the UAV is configured to determine a trajectory for the mission based on the received assignment. Further, the controller determines control commands that cause the UAV to track the trajectory. Alternatively, in some embodiments, the system 201a determines the control commands to track the trajectory. The system 201a further transmits determined control commands to the controller. The controller controls the UAV according to the control commands to track the trajectory for the mission.

### Exemplary Embodiments

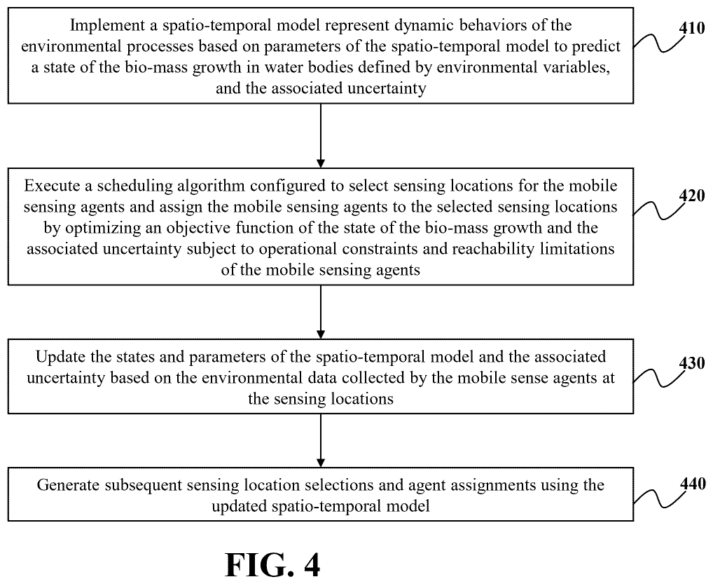

FIG. 4 illustrates a block diagram of a system for dynamic monitoring of spatio-temporal environmental processes, such as bio-mass growth in water bodies, using a plurality of mobile sensing agents equipped with sensors for collecting environmental data, according to some embodiments. The system integrates computational and sensing capabilities to provide adaptive and efficient monitoring of environmental phenomena characterized by complex spatial and temporal dynamics.

The system comprises a processor and a memory, where the memory stores instructions that, when executed by the processor, enable the implementation of several critical functionalities to achieve dynamic and adaptive monitoring. These functionalities are described as follows: Implementing a Spatio-Temporal Model (Block 410): The system implements a spatio-temporal model that represents the dynamic behaviors of the monitored environmental processes. This model uses parameters such as growth rates, diffusion coefficients, and external environmental influences to predict the state of bio-mass growth in the water body. The state is defined by environmental variables, which may include bio-mass density, nutrient concentrations, oxygen levels, and temperature profiles. The spatio-temporal model provides a structured framework for describing the evolution of bio-mass growth over space and time, accounting for both intrinsic dynamics (e.g., growth and dispersion) and external factors (e.g., nutrient influx or environmental forcing). This model serves as the foundation for the system's ability to predict and adapt to changes in the monitored environment.

For example, in one embodiment, to represent the dynamic behaviors of bio-mass growth, the system employs a parameterized state-space model that captures both spatial and temporal correlations. This model is described by the discrete-time evolution function:

$${x}_{k + 1} = f ( {x}_{k} , {u}_{k} ; θ ) + {w}_{k} ,$$

where xₖ ∈ [symbol] ⁿ^{ₓ} is the state vector representing bio-mass densities across spatial locations, uₖ ∈ [symbol] ⁿ^{ᵤ} denotes external inputs such as nutrient levels, and θ∈ [symbol] ⁿ^{_{θ}} represents model parameters like growth rates and diffusion coefficients. The zero-mean process noise wₖ captures uncertainties in the model. Therefore, for a given current state xₖ and external inputs uₖ, this model predicts the state xₖ₊₁ at the next time step.

In some embodiments, the model's structure accounts for processes like logistic growth, with carrying capacities modulated by environmental factors, and diffusion, representing the spatial spread of bio-mass due to water currents:

$$\dot{x} ( t ) = α u ( t ) x ( t ) ( 1 - \frac{x ( t )}{u ( t )} ) + {\sum }_{i = 1}^{3} {β}_{i} \frac{{\partial }^{2} x ( t )}{\partial {z}_{i}^{2}} .$$

Here, the model is represented as continuous-time partial differential equation (PDE), α and βᵢ are growth and diffusion parameters, respectively, and the index i=1, 2, 3 correspond to the three spatial dimensions. Such a PDE is discretized both spatially and temporally to obtain the afore-discussed discrete-time prediction model.

Furthermore, this model can also be used to estimate uncertainty in the state predictions. According to some embodiments, uncertainty in the state estimates is quantified by the covariance matrix Pₖ as follows:

$${P}_{k + 1} = {F}_{k} {P}_{k} {F}_{k}^{T} + {Q}_{k} ,$$

where Fₖ is the Jacobian of f with respect to xₖ, and Qₖ denotes the uncertainty, i.e., covariance matrix of the noise wₖ.
Executing a Scheduling Algorithm (Block 420): The system executes a scheduling algorithm that determines where and when data should be collected by the mobile sensing agents. This algorithm performs two interdependent tasks: selecting sensing locations and assigning mobile sensing agents to those locations. These decisions are guided by the optimization of an objective function based on the state of the bio-mass growth. The objective function may aim to minimize uncertainty in the estimated variables, reduce travel costs for the agents, or balance multiple objectives, such as accuracy and resource efficiency. The scheduling process is subject to operational constraints, such as remaining battery life of drones, communication range, and environmental obstacles, as well as reachability limitations that ensure the sensing agents can feasibly access the selected locations within their capabilities.

The scheduling algorithm addresses the selection of sensing locations and the assignment of mobile sensing agents to these locations. According to some embodiments, the system optimizes an objective function quantifying the estimation quality, such as minimization of the log-determinant of the posterior covariance matrix:

$${J}_{e s t} ( {S}_{k} ) = log det ( {P}_{k \vert k} ) ,$$

Where Sₖ denotes the set of selected sensing locations and P_{k|k} is the updated covariance matrix representing uncertainty if the measurements collected at the sensing locations Sₖ at time step k were assimilated.

Selecting an optimal finite subset Sₖ from all available sensing locations is an intractable combinatorial optimization problem. Greedy methods offer a computationally efficient solution by iteratively selecting the next best sensing location that maximizes the incremental information gain. The algorithm is enhanced to ensure dynamic feasibility, incorporating constraints like agent reachability and minimization of agent team's total travel costs.

Alternatively, Mixed-Integer Linear Programming (MILP) formulates the scheduling problem to simultaneously minimize travel costs and maximize estimation accuracy, providing globally optimal solutions for finite problem sizes. Reinforcement Learning (RL) may also be employed to adaptively learn optimal scheduling policies in complex and dynamic environments. Heuristic control rules can also be applied for simplicity, such as prioritizing sensing locations with the highest uncertainty or proximity to agents.

Agents' control mechanisms guide the mobile sensing agents to execute the generated schedules, i.e., to travel to the assigned locations and collect measurements of environmental variables using onboard sensors and instruments. For instance, Model Predictive Control (MPC) anticipates future states to optimize control inputs, ensuring agents follow efficient paths while accounting for environmental changes and operational constraints.

Updating States and Parameters of the Spatio-Temporal Model (Block 430): After the mobile sensing agents collect environmental data from their assigned locations, the system uses this data to update the states and parameters of the spatio-temporal model. This process involves data assimilation techniques, such as the Extended Kalman Filter (EKF) or other methods, to refine the states and model's parameters based on observed measurements. For example, growth rates or diffusion coefficients may be adjusted to reflect current environmental conditions more accurately. This iterative parameter refinement ensures that the model remains aligned with real-world observations, enhancing its predictive accuracy and reliability.

For example, in one embodiment, to update the state and parameter estimates, the system employs data assimilation techniques like the Extended Kalman Filter (EKF). The EKF linearizes the non-linear model around the current estimates and updates the states and parameters based on collected measurements:

$${\tilde{x}}_{k}^{+} = {\tilde{x}}_{k}^{-} + {\tilde{K}}_{k} ( {y}_{k} - h ( {\tilde{x}}_{k}^{-} ) ) ,$$

where \tilde{K}ₖ is the Kalman gain and yₖ represents sensor measurements,

$${\tilde{x}}_{k}^{-}$$

denotes the augmented vector of states and parameters estimate prior to the assimilation of measurements, and h denotes the measurement model.

For scenarios with highly non-linear dynamics, Particle Filters can approximate the posterior distribution of the states and parameters using weighted particle sets, offering robustness to non-Gaussian uncertainties.

Generating Subsequent Sensing Location Selections and Agent Assignments (Block 440): Using the updated spatio-temporal model, the system generates new sensing location selections and agent assignments. The updated model provides improved predictions of bio-mass growth dynamics, which inform the scheduling algorithm for the next cycle of data collection. By incorporating feedback from the most recent observations, the system continuously improves its monitoring strategy, ensuring that future sensing efforts are targeted where they are most needed and resource-efficient.

This architecture establishes a feedback loop where data collected by the mobile sensing agents refines the spatio-temporal model, and the refined model, in turn, informs subsequent data collection efforts. By dynamically adapting to environmental conditions and optimizing the deployment of sensing agents, the system achieves enhanced monitoring accuracy, efficiency, and adaptability. FIG. 4 encapsulates the interplay of modeling, scheduling, data assimilation, and feedback processes that underpin this innovative approach to environmental monitoring.

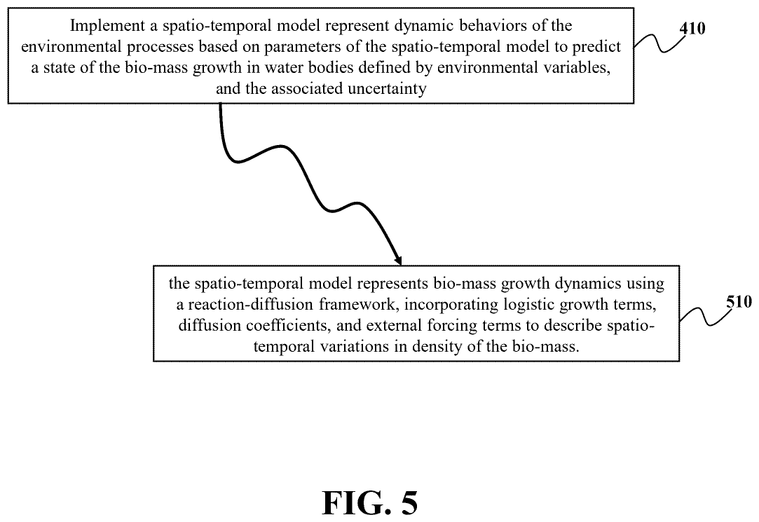

FIG. 5 illustrates a schematic of a system in which bio-mass growth dynamics are modeled using a reaction-diffusion framework according to one embodiment. This framework provides a comprehensive representation of the spatial and temporal evolution of bio-mass density in water bodies. It incorporates three key components: logistic growth terms, diffusion coefficients, and external forcing terms, each of which plays a specific role in capturing the complexity of bio-mass behavior.

The logistic growth component models how bio-mass grows in response to available resources while respecting natural limitations, such as nutrient availability or sunlight. Initially, bio-mass may grow exponentially, but as it approaches the environment's carrying capacity, the growth rate decreases and eventually stabilizes. This process is mathematically represented by the equation:

$$\frac{\partial B}{\partial t} = rB ( 1 - \frac{B}{K} ) ,$$

where B(z, t) represents the bio-mass density at some spatial location z in the water body at time t, r is the intrinsic growth rate, and K is the carrying capacity of the environment. In different implementations, the location z may be characterized by a 1-dimensional, 2-dimensional or 3-dimensional spatial coordinates.

This formulation ensures that the model realistically reflects biological growth constraints by incorporating resource limitations.

The diffusion component accounts for the spatial spread of bio-mass across a water body. Bio-mass disperses through processes such as water currents and mixing, which are represented in the model by the diffusion term: D∇²B,
where D is the diffusion coefficient and ∇² is the Laplacian operator describing spatial gradients. This term ensures that the model captures how bio-mass spreads over time, avoiding the unrealistic assumption that it remains concentrated in a single area. By incorporating diffusion coefficients, the model accurately simulates the natural distribution of bio-mass, providing a detailed depiction of its behavior in dynamic environments.

External forcing terms introduce the influence of environmental factors on bio-mass growth. These terms account for inputs such as nutrient influx, temperature fluctuations, or pollutant levels, which can vary spatially and temporally. The external influences are modeled as:
F(z, t),
where F(z, t) represents the spatio-temporally varying external factors. These terms enable the model to adapt to real-time changes in environmental conditions, enhancing its predictive accuracy.

When combined, these components form the reaction-diffusion equation:

$$\frac{\partial B}{\partial t} = rB ( 1 - \frac{B}{K} ) + D {∇}^{2} B + F ( z , t ) ,$$

which provides a structured and biologically grounded representation of bio-mass dynamics. In some embodiments, the carrying capacity of the environment may be modeled as a time-varying signal K(t) directly accounting for the effects of external factors on the carrying capacity and bio-mass growth.

This reaction-diffusion framework offers several advantages. It integrates biological realism by modeling bio-mass growth based on established ecological principles, such as resource limitations and carrying capacity. The diffusion term enhances spatial precision, allowing the model to simulate the heterogeneity of bio-mass distribution across large and complex water bodies. Additionally, the external forcing terms make the framework highly responsive to environmental changes, ensuring that it remains accurate and relevant even in dynamic settings.

Furthermore, the framework is flexible and scalable, capable of accommodating different spatial and temporal resolutions depending on monitoring needs. It is also well-suited for integration with data assimilation techniques, such as the Extended Kalman Filter, which can refine model parameters based on real-world measurements. By continuously updating and improving the model, the system achieves a robust and adaptive approach to monitoring bio-mass growth.

In effect, the reaction-diffusion framework depicted in FIG. 5 provides a practical method for modeling bio-mass dynamics in water bodies. By combining logistic growth, diffusion processes, and external environmental influences, this approach captures the intricate interplay of biological, physical, and environmental factors. Its versatility and accuracy make it an effective tool for ecological monitoring and resource management.

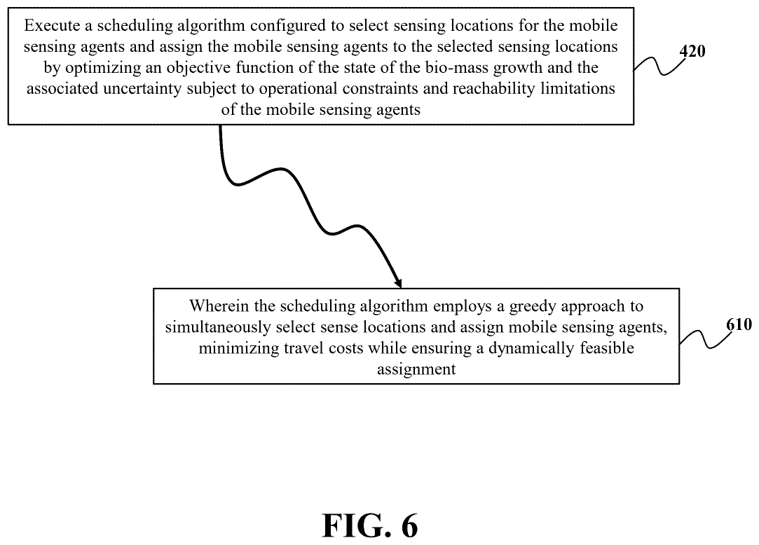

FIG. 6 depicts a method in which the scheduling algorithm 420 employs a greedy approach 610 to optimize the deployment of mobile sensing agents for monitoring spatio-temporal environmental processes. This method simultaneously selects sensing locations and assigns mobile sensing agents, aiming to minimize travel costs while ensuring that the assignments are dynamically feasible. By focusing on real-time decision-making, the greedy approach provides an efficient and practical solution for environmental monitoring.

The method evaluates potential sensing locations and available mobile sensing agents. At each step, the method calculates the utility of unvisited sensing locations, prioritizing those that maximize the monitoring objective. The objective can be formalized as:

$${J}_{est} ( {S}_{k} ) = log det ( {P}_{k \vert k} ) ,$$

Where Sₖ denotes the set of selected sensing locations and P_{k|k} is the updated covariance matrix representing uncertainty if the measurements collected at the sensing locations Sₖ were assimilated. Minimizing Jₑₛₜ corresponds to reducing the uncertainty in the state estimates.

Simultaneously, mobile sensing agents are assigned to the selected sensing locations in a manner that minimizes the travel cost:

$${C}_{travel} = {\sum }_{i ∈ 𝒜} {\sum }_{j ∈ 𝒮} {c}_{ij} {x}_{ij} ,$$

where cᵢⱼ represents the travel cost (e.g., distance or energy expenditure) for agent i∈ [symbol] to reach sensing location j∈ [symbol] , and xᵢⱼ is a binary variable which equals 1 if the agent i is assigned to location j, and 0 otherwise. The assignment must satisfy dynamic feasibility constraints, such as:
dᵢⱼ≤Dₘₐₓ, ∀i,j,
where dᵢⱼ is the travel cost (e.g., distance) between the current position of agent i and sensing location j, and Dₘₐₓ is the maximum allowable travel cost.

The greedy algorithm proceeds iteratively. In each iteration, the sensing location sᵢ is chosen from a finite set of all possible sensing locations in a greedy manner to maximize the reduction in Jₑₛₜ, and an agent that satisfies the dynamic feasibility constraints and encounters the smallest travel cost to the selected sensing location is assigned for the measurement task. The selected sensing location and the assigned agent are removed from the pool of available sensing locations and agents before the next iteration of the algorithm. Additionally, any sensing locations that are not reachable by the remaining untasked agents are eliminated from the pool of available sensing locations to ensure that dynamical reachability constraints are satisfied. This iterative process continues until all agents are deployed or all required sensing locations are visited.

Dynamic feasibility plays a beneficial role in this method. In various implementations, the algorithm incorporates constraints such as battery life, communication range, and environmental obstacles to ensure that selected sensing locations are reachable and practical within the agents' operational limits.

The greedy approach offers several advantages. Its computational efficiency makes it particularly well-suited for real-time applications, enabling quick decision-making in dynamic environments. The simplicity of the algorithm allows for straightforward implementation, and for objectives that are submodular, such as maximizing information gain, the greedy solution provides a provable approximation to the global optimum.

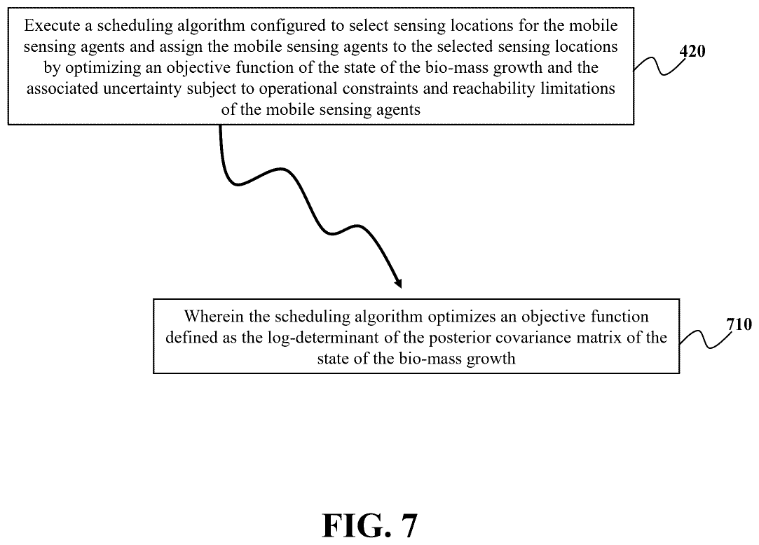

FIG. 7 illustrates a schematic of a system according to one embodiment, in which the scheduling algorithm 420 is designed to optimize an objective function 710. In this embodiment an objective function defined as the log-determinant of the posterior covariance matrix, which quantifies the uncertainty in the state estimates of bio-mass growth. By minimizing this objective function, the system prioritizes data collection efforts that most effectively reduce uncertainty in the states of bio-mass growth model.

The posterior covariance matrix, denoted as P_{k|k}, represents the uncertainty in the estimated states of the bio-mass growth after assimilating new observational data. The log-determinant of this matrix provides a scalar measure of overall uncertainty, capturing the combined variability across all state variables. The objective function is expressed as:

$${J}_{est} = log det ( {P}_{k \vert k} ) ,$$

where minimizing Jₑₛₜ corresponds to reducing the volume of the uncertainty ellipsoid in the state space. A smaller Jₑₛₜ indicates greater confidence in the model's state estimates.

The scheduling algorithm operates iteratively to achieve this objective. First, the spatio-temporal model predicts the current state of bio-mass growth and estimates the prior covariance matrix, P_{k|k-1}, which reflects the uncertainty before new data is incorporated. Next, the algorithm evaluates potential sensing locations by simulating the reduction in uncertainty that would result from collecting data at those locations. This involves computing the updated covariance matrix, P_{k|k}, for each candidate location and determining the corresponding value of Jₑₛₜ.

Based on these evaluations, the algorithm selects the sensing location that maximizes the reduction in uncertainty and assigns a mobile sensing agent to that location. This assignment considers practical constraints, such as the reachability of the location, the agent's energy capacity, and operational limits. The process repeats until all agents are deployed or all required locations have been covered.

The use of the log-determinant metric in this embodiment offers several advantages. It provides a comprehensive measure of uncertainty, capturing the overall confidence in all state variables simultaneously. The metric is mathematically tractable, making it computationally efficient to calculate and optimize. Additionally, it adapts seamlessly to complex spatio-temporal models by dynamically updating the posterior covariance matrix as new data becomes available.

In practical applications, such as monitoring bio-mass growth in water bodies, this approach ensures that data collection is focused on areas where it has the most significant impact. For example, regions with high variability in bio-mass density or where model predictions are less reliable are prioritized for sensing. As the system incorporates new data, it refines the spatio-temporal model, generating optimized schedules for future sensing efforts. This iterative process ensures that monitoring is both effective and resource-efficient.

In effect, the embodiments of FIG. 7 highlights how optimizing an objective function based on the log-determinant of the posterior covariance matrix enhances the system's ability to monitor bio-mass growth. By focusing on reducing uncertainty, the system achieves accurate and reliable environmental monitoring, adapting dynamically to changes in the monitored environment. This approach integrates advanced optimization techniques into the monitoring framework, ensuring robust and efficient decision-making.

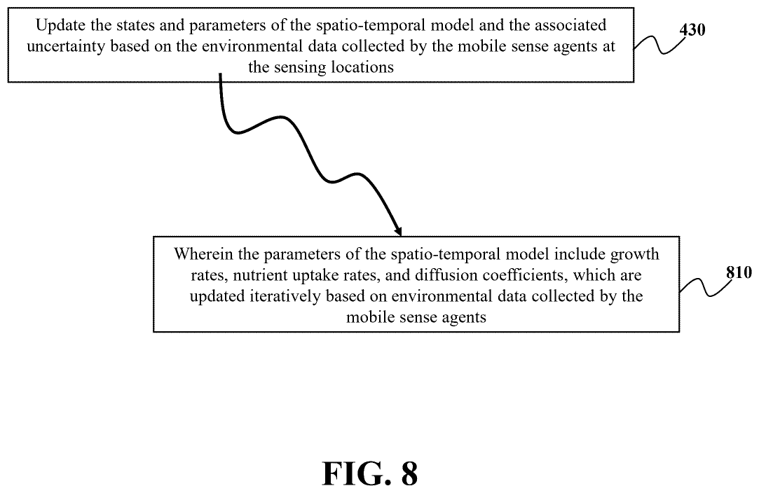

FIG. 8 illustrates an embodiment of a system where the parameters of a spatio-temporal model are iteratively updated 810 using environmental data collected by mobile sensing agents. These parameters include growth rates, nutrient uptake rates, and diffusion coefficients, each of which plays an important role in capturing the dynamics of bio-mass growth in water bodies. By refining these parameters iteratively, the system adapts to changing environmental conditions and enhances the accuracy of its predictions.

The growth rate (r) represents the rate at which bio-mass density increases under favorable conditions, such as the availability of nutrients and suitable temperatures. This parameter is crucial for modeling biological processes and varies based on external influences. For example, seasonal changes or variations in nutrient levels may alter r, requiring periodic recalibration to ensure the model reflects observed behaviors. Mathematically, growth can be expressed in the model using:

$$\frac{\partial B}{\partial t} = rB ( 1 - \frac{B}{K} ) ,$$

where B represents the bio-mass density, and K is the carrying capacity of the environment.

Bio-mass growth is also proportional to nutrients availability (Nₐᵥₐᵢₗ). In some embodiments, nutrient availability is modeled using the nutrient uptake rate:

$${N}_{avail} = {N}_{Total} - α B$$

Where N_{Total} denotes total influx of nutrients and the nutrient uptake rate (a) quantifies how effectively bio-mass absorbs nutrients from its surroundings. This parameter directly influences how bio-mass growth responds to fluctuations in nutrient availability, such as influxes from agricultural runoff or upwelling. Adjustments to a ensure that the model can account for dynamic interactions between nutrient levels and bio-mass growth. For instance, a higher nutrient uptake rate might lead to more rapid growth in nutrient-rich regions.

The diffusion coefficient (D) describes the spatial spread of bio-mass due to processes like water currents or mixing. Diffusion coefficients are integral for modeling how bio-mass disperses across a water body, capturing spatial patterns and heterogeneity in bio-mass density. The diffusion term in the model can be expressed as:

$$D {∇}^{2} B ,$$

where ∇²B represents the Laplacian operator capturing spatial gradients.

The system refines these parameters iteratively using data assimilation techniques. Mobile sensing agents, such as drones, collect environmental data from strategically selected locations. Measurements of variables like bio-mass density, nutrient concentrations, and temperature profiles are used to update the model parameters. For instance, if observed bio-mass growth is slower than predicted, the growth rate (r) is adjusted downward, and/or changes in nutrient levels lead to recalibrations of the nutrient uptake rate (α), and/or patterns of bio-mass dispersion influence updates to the diffusion coefficient (D).

This iterative process ensures that the model remains aligned with the current environmental conditions, dynamically adapting to new information. For example, when a nutrient influx from agricultural runoff is detected, the nutrient uptake rate may increase to reflect the system's enhanced growth potential. Similarly, observed shifts in bio-mass dispersion caused by strong currents may prompt updates to the diffusion coefficient, ensuring the model captures these spatial dynamics accurately.

By continuously refining its parameters, the embodiment offers several advantages. It allows the model to adapt to environmental changes, improving its predictive accuracy over time. This iterative updating process also supports scalability, enabling the model to function effectively across different spatial and temporal resolutions. Additionally, by incorporating real-world observations, the system provides a reliable foundation for monitoring bio-mass growth and informing management decisions.

In effect, the embodiment of FIG. 8 illustrates how iterative updates to model parameters, such as growth rates, nutrient uptake rates, and diffusion coefficients, allow the system to remain responsive and accurate. By integrating environmental data collected by mobile sensing agents, the model dynamically adapts to changing conditions, providing a robust tool for understanding and managing bio-mass growth in water bodies.

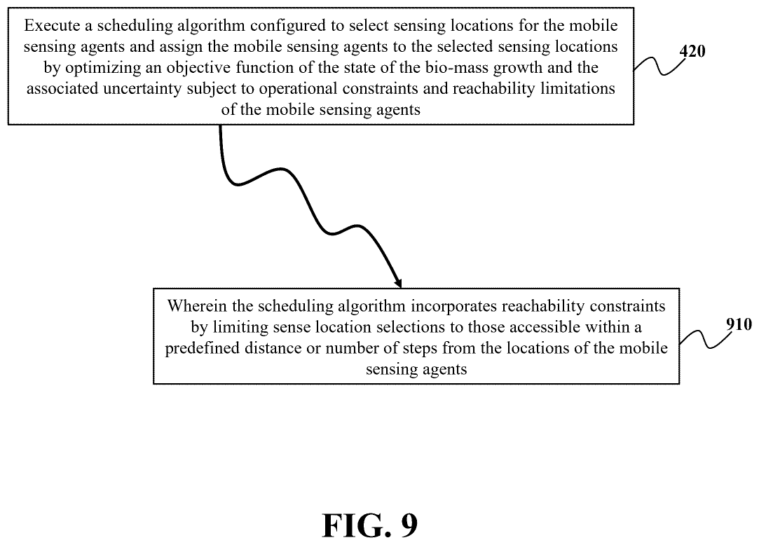

FIG. 9 illustrates a schematic of an embodiment of a system where the scheduling algorithm 420 integrates 910 reachability constraints to ensure that sensing locations selected for monitoring are both accessible and practical for mobile sensing agents. These constraints limit the choices of sensing locations to those that agents can reach within a predefined number of steps or distances. By incorporating these constraints, the system ensures that the schedules it generates are feasible, resource-efficient, and aligned with the operational capabilities of the sensing agents.

The reachability of a sensing location is determined based on the distance between the current position of a mobile sensing agent and the potential sensing location. For each sensing location sᵢ and mobile sensing agent aⱼ, the algorithm evaluates the distance d(sᵢ, aⱼ), ensuring it satisfies the condition:

$$d ( {s}_{i} , {a}_{j} ) \leq {D}_{max} ,$$

where d(sᵢ, aⱼ) represents the distance required for agent aⱼ to reach sensing location sᵢ, and Dₘₐₓ is the maximum allowable distance. In a discretized spatial domain comprising of a number of grid cells, the distance may be quantified by the number of steps an agent needs to reach a sensing location, wherein each step allows movement to an adjacent cell. Accordingly, Dₘₐₓ may specify the maximum number of steps an agent is allowed to take.

The threshold Dₘₐₓ is determined based on agent-specific operational factors, such as battery capacity, speed, and environmental conditions. Locations that do not meet this criterion are excluded from the scheduling process.

The scheduling algorithm applies these constraints in a structured manner to ensure that all selected sensing locations are within feasible reach of the mobile sensing agents. Initially, the algorithm pre-filters the available sensing locations, retaining only those that satisfy the reachability condition. This step reduces computational complexity by narrowing the optimization to viable options. As the scheduling process progresses, the algorithm dynamically updates the reachability constraints in response to changes in the environment or the positions of the agents. For example, if an agent moves closer to a sensing location, the distance d(sᵢ, aⱼ) is recalculated, potentially adding new locations to the candidate pool.

To integrate these constraints into the scheduling process, the algorithm incorporates them into the optimization framework. For instance, when minimizing travel costs or uncertainty, the algorithm solves an objective function such as:

$$min ( {J}_{cost} ) subject to d ( {s}_{i} , {a}_{j} ) \leq {D}_{max} ,$$

where J_{cost} represents the optimization objective, which could be reducing travel cost, maximizing information gain, or minimizing uncertainty in the spatio-temporal model.

Reachability constraints provide several benefits to the scheduling algorithm. By ensuring that selected sensing locations are reachable under the dynamics of the agents, the algorithm guarantees the feasibility of the schedules. It also enhances resource efficiency by minimizing unnecessary travel, conserving energy, and extending the operational range of the agents. Additionally, the adaptive nature of these constraints allows the system to respond dynamically to changing conditions, such as shifts in agent positions or environmental barriers, ensuring robust performance.

In real-world applications, such as monitoring bio-mass growth in water bodies, reachability constraints ensure that sensing agents, such as drones, are assigned to locations within their operational limits. For instance, a drone with limited battery life operating in a large water body may prioritize nearby sensing locations to conserve energy while still collecting valuable data. If the environmental conditions change or the agent's position shifts, the algorithm dynamically recalculates the reachability of sensing locations and adjusts the schedule accordingly.

In effect, the embodiment of FIG. 9 highlights how the integration of reachability constraints into the scheduling algorithm ensures the practicality and efficiency of the monitoring system. By incorporating equations that account for distance and accessibility, the system achieves a balance between feasibility and effectiveness, enabling adaptive and reliable environmental monitoring even in resource-constrained conditions.

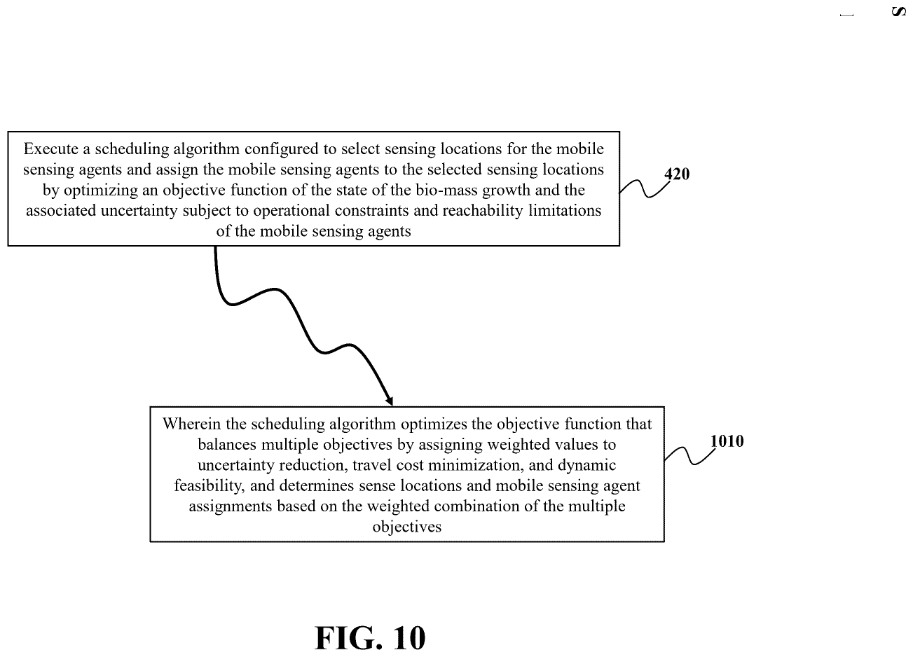

FIG. 10 illustrates a schematic of an embodiment of a system in which the scheduling algorithm 420 optimizes 1010 an objective function designed to balance multiple objectives in the environmental monitoring process. In one implementation, this optimization framework integrates three exemplar components: reducing uncertainty in the spatio-temporal model estimates, minimizing travel costs, and ensuring dynamic feasibility of agent assignments. Each objective is assigned a weight that reflects its relative importance, enabling the system to adapt to different monitoring needs and constraints.

The optimization problem is defined through a weighted objective function:

$$J = α {J}_{uncertainty} + β {J}_{travel} + γ {J}_{feasibility} ,$$

where:
J_{uncertainty} measures the uncertainty in the state estimates, represented by the log-determinant of the posterior covariance matrix:

$${J}_{uncertainty} = log det ( {P}_{k \vert k} ) ,$$

where P_{k|k} reflects the updated covariance matrix at time step k, quantifying the confidence in the state estimates;
Jₜᵣₐᵥₑₗ quantifies the total travel cost of assigning mobile sensing agents to sensing locations:

$${J}_{travel} = {\sum }_{i ∈ 𝒜} {\sum }_{j ∈ 𝒮} {c}_{ij} {x}_{ij} ,$$

where cᵢⱼ represents the cost (such as distance or energy expenditure) for agent i to move to location j, and xᵢⱼ is a binary variable indicating whether agent i is assigned to location j;
J_{feasibility} ensures that reachability constraints are respected by penalizing assignments that violate operational limits, maintaining practical feasibility in agent deployments.

The parameters α, β, and γ serve as weights for the respective components of the objective function, allowing the system to prioritize different goals. By tuning these weights, the system can adapt to specific operational requirements, such as focusing on reducing uncertainty in high-stakes scenarios or emphasizing travel efficiency in resource-limited situations.

The optimization process follows a structured approach: (1) Initialization: The algorithm begins by evaluating all candidate sensing locations and agent assignments based on the weighted objective function. The initial weights α, β, and γ are applied to compute the combined value of J for each possible assignment. (2) Selection of Assignments: The algorithm iteratively identifies sensing locations and agent assignments that minimize J, ensuring an optimal trade-off between uncertainty reduction, travel cost minimization, and dynamic feasibility. (3) Dynamic Adjustments: As environmental conditions evolve or operational priorities shift, the algorithm recalculates the weights and constraints dynamically, adjusting the objective function to reflect the current monitoring needs.

This weighted optimization approach offers several advantages. It provides flexibility in balancing competing goals, allowing the system to adapt to different monitoring scenarios. For instance, increasing a prioritizes uncertainty reduction, ensuring that data collection focuses on areas with the greatest impact on improving model accuracy. Conversely, a higher β weight minimizes travel costs, making the system more efficient in energy-constrained environments. The inclusion of J_{feasibility} ensures that all assignments remain practical, respecting the physical and operational limitations of the mobile sensing agents.

In real-world applications, such as monitoring bio-mass growth in water bodies, this approach ensures that the scheduling algorithm is both efficient and effective. For example, when uncertainty in bio-mass density predictions is high, the algorithm may prioritize data collection in areas where measurements will most significantly refine the model. Simultaneously, the travel cost and feasibility constraints ensure that sensing agents operate within their energy budgets and reach only accessible locations.

In effect, the embodiment of FIG. 10 demonstrates how the scheduling algorithm leverages a weighted optimization framework to balance multiple objectives. By integrating uncertainty reduction, travel cost minimization, and dynamic feasibility, the system provides a robust and adaptable approach to environmental monitoring, ensuring that data collection is both impactful and resource efficient. This capability allows the system to maintain high performance across diverse operational contexts and environmental challenges.

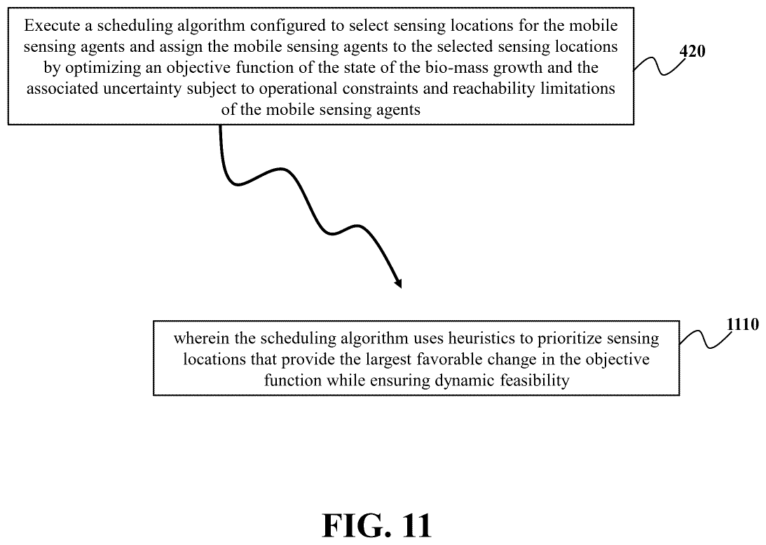

FIG. 11 illustrates a schematic of an embodiment of a system in which the scheduling algorithm 420 employs a heuristic-based approach 1110 to prioritize sensing locations for mobile sensing agents. This method focuses on selecting locations that provide the most significant improvement to the system's objective function while ensuring that the assignments remain dynamically feasible. By leveraging incremental optimization and feasibility constraints, this approach offers a practical and efficient solution for real-time environmental monitoring.

In this embodiment, the scheduling algorithm evaluates each potential sensing location sᵢ based on the improvement it contributes to the system's objective function. The improvement is quantified as:

$$Δ J ( {s}_{i} ) = {J}_{current} - {J}_{new} ( {s}_{i} ) ,$$

where J_{current} represents the value of the objective function before considering sᵢ, and J_{new}(sᵢ) represents the value after incorporating sᵢ. Locations with the highest ΔJ(sᵢ) are prioritized, ensuring that each selected location provides maximum benefit to the system's monitoring objectives.

To ensure the practicality of the selected sensing locations, the algorithm incorporates dynamic feasibility constraints. A sensing location sᵢ is deemed feasible for an agent aⱼ if the distance between the two satisfies:

$$d ( {s}_{i} , {a}_{j} ) \leq {D}_{max} ,$$

where d(sᵢ, aⱼ) is the distance between sᵢ and aⱼ, and Dₘₐₓ is the maximum allowable distance defined by the agent's operational capabilities, such as battery life or mobility constraints. Locations that do not meet this criterion are excluded from the selection process, ensuring that the assignments are both feasible and efficient.

The heuristic-based scheduling algorithm operates iteratively. First, it evaluates the incremental improvement ΔJ(sᵢ) for all candidate sensing locations. Next, it filters out locations that fail to meet the dynamic feasibility constraints. The algorithm then assigns agents to the highest-priority locations based on their positions and operational constraints. This process is repeated until all agents are deployed or all feasible locations are covered.

This heuristic approach provides several advantages. By focusing on incremental improvements, the algorithm ensures that each sensing action contributes meaningfully to the overall monitoring objectives. The incorporation of dynamic feasibility constraints guarantees that the system remains practical and resource-efficient, even in challenging operational environments. Additionally, the simplicity of the heuristic method allows it to operate in real-time, making it well-suited for dynamic and rapidly changing conditions.

In practical applications, such as monitoring bio-mass growth in water bodies, this method directs agents to areas where their measurements can have the most significant impact. For instance, it may prioritize regions with high uncertainty or areas where recent environmental changes have occurred. At the same time, the feasibility constraints ensure that agents are only deployed to locations they can realistically access, maximizing the effectiveness of data collection efforts.

In effect, the embodiment of FIG. 11 demonstrates how a heuristic-driven scheduling algorithm can optimize sensing location selection and agent assignment. By combining the principles of incremental improvement and dynamic feasibility, the system achieves a balance between effectiveness and practicality, making it a robust tool for real-time environmental monitoring.

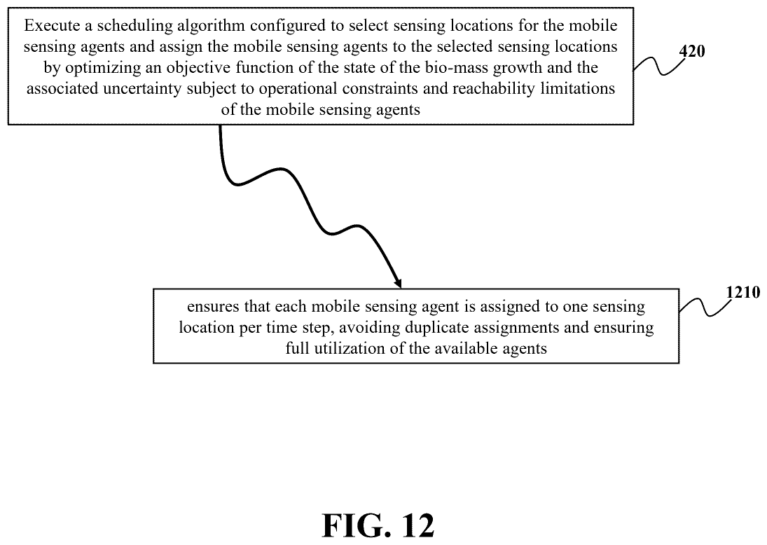

FIG. 12 illustrates a schematic of an embodiment of a system in which the scheduling algorithm 420 ensures 1220 that each mobile sensing agent is assigned to one sensing location per time step, avoiding duplicate assignments and ensuring full utilization of the available agents. In the system according to this embodiment, the scheduling algorithm ensures efficient and conflict-free deployment of mobile sensing agents by assigning each agent to a single sensing location during each time step. This approach guarantees that every agent is utilized to its full potential while avoiding redundant assignments, ensuring the system operates effectively and without resource conflicts.

To achieve this, the algorithm enforces a unique assignment constraint. For every time step, each mobile sensing agent is allocated to exactly one sensing location. This constraint ensures that no agent is scheduled for multiple locations simultaneously, streamlining resource utilization and eliminating the possibility of overlapping tasks. Mathematically, this can be expressed as:

$${\sum }_{i ∈ 𝒮} {x}_{i j} ( t ) = 1 ∀ j ∈ 𝒜 ,$$

where xᵢⱼ(t) is a binary variable indicating whether agent aⱼ is assigned to location sᵢ at time step t.

In addition to ensuring unique assignments, the algorithm optimizes the use of all available sensing agents. Unless constrained by operational limitations such as battery capacity or physical barriers, every agent is actively deployed to collect environmental data. This exhaustive utilization strategy ensures that the system maximizes its coverage and efficiency during each monitoring cycle.

The scheduling algorithm also prevents multiple agents from being assigned to the same sensing location at the same time. This avoidance of overlap reduces redundant data collection, broadens the spatial coverage, and enhances the overall quality of the gathered data. The constraint ensuring no overlap can be expressed as:

$${\sum }_{j ∈ 𝒜} {x}_{i j} ( t ) \leq 1 ∀ i ∈ 𝒮 .$$

This systematic approach to assigning sensing agents offers several benefits. By ensuring that every agent is assigned to a unique and feasible location, the system avoids conflicts and redundant operations. This improves resource utilization, as all agents contribute to data collection efforts without interference or duplication. The algorithm also dynamically adjusts assignments in response to changes in environmental conditions or operational factors, such as variations in agent mobility or newly identified sensing priorities.

For instance, in a practical scenario involving the monitoring of bio-mass growth in a large water body, the scheduling algorithm ensures that drones are allocated to distinct sensing locations during each time step. If environmental factors, such as strong currents or uneven terrain, limit access to certain locations, the algorithm reallocates agents to alternative sites while maintaining the system's overall efficiency and effectiveness.

By implementing these principles, the system achieves conflict-free, efficient, and adaptive deployment of mobile sensing agents. This ensures comprehensive and high-quality data collection, supporting accurate and reliable environmental monitoring over diverse spatial and temporal scales.

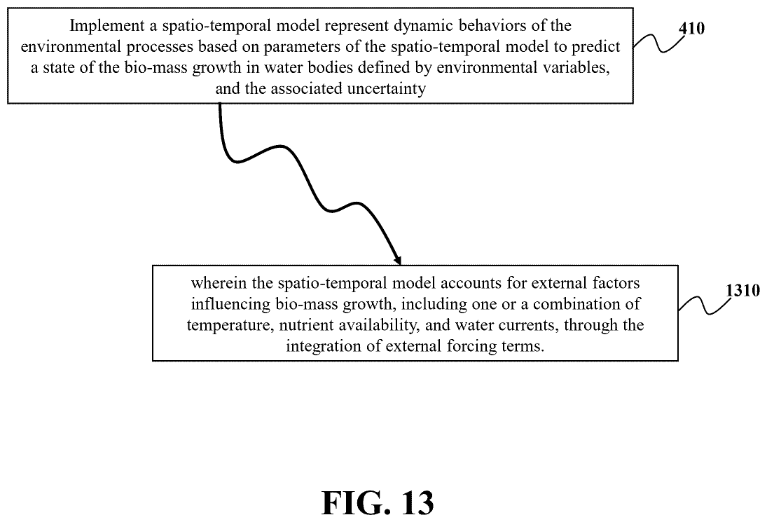

FIG. 13 illustrates a schematic of an embodiment of a system in which the spatio-temporal model 410 accounts 1310 for external factors influencing bio-mass growth, including one or a combination of temperature, nutrient availability, and water currents, through the integration of external forcing terms. In this embodiment, the spatio-temporal model used by the system accounts for external factors that significantly influence bio-mass growth dynamics, such as temperature, nutrient availability, and water currents. These factors are integrated into the model through external forcing terms, enabling a more comprehensive representation of the bio-mass growth processes in water bodies.

The dynamics of bio-mass growth are modeled using a reaction-diffusion framework, incorporating terms for logistic growth, diffusion, and external forcing. The state equation for the bio-mass density B(z, t) at location z and time t is expressed as:

$$\frac{\partial B ( z , t )}{\partial t} = r B ( z , t ) ( 1 - \frac{B ( z , t )}{K} ) + D {∇}^{2} B ( z , t ) + F ( z , t ) ,$$

where:
r represents the intrinsic growth rate of the bio-mass, K denotes the carrying capacity of the environment, D∇²B(z, t) is the diffusion term describing the spatial spread of bio-mass, and F(z, t) represents the external forcing term.

The external forcing term F(z, t) encapsulates the impact of environmental variables and is modeled as:

$$F ( z , t ) = {α}_{T} T ( z , t ) + {α}_{N} N ( z , t ) + {α}_{C} C ( z , t ) ,$$

where:
   T(z, t) represents the temperature at location z and time t, N(z, t) is the nutrient availability, C(z, t) captures the effects of water currents, and α_{T}, α_{N}, and ac are sensitivity coefficients corresponding to the respective factors.

Additionally or alternatively, the effect of external factors can be incorporated into the model by accounting for effects on the carrying capacity K(z, t):

$$K ( z , t ) = g ( T ( z , t ) , N ( z , t ) , C ( z , t ) , )$$

Where g(⋅) denotes a potentially nonlinear function mapping external signals to the carrying capacity of the environment.

By incorporating these forcing terms, the model dynamically adapts to changes in environmental conditions, such as seasonal temperature variations, nutrient influxes due to runoff, or shifts in water current patterns. This enhances the accuracy of bio-mass growth predictions and allows the system to respond proactively to environmental changes.

The inclusion of external forcing terms offers several advantages. It enhances the predictive accuracy of the model by integrating the environmental drivers of bio-mass dynamics, allowing the system to produce more realistic growth and dispersion patterns. Additionally, this approach ensures adaptability, as the model dynamically adjusts to reflect variations in temperature, nutrients, and water currents. Finally, the comprehensive nature of the model supports informed decision-making for environmental monitoring and management by providing insights into the interactions between bio-mass and its surrounding environment.

Through this approach, the embodiment illustrated in FIG. 13 demonstrates how external factors influencing bio-mass growth can be effectively incorporated into a reaction-diffusion framework, enhancing the overall monitoring and predictive capabilities of the system.

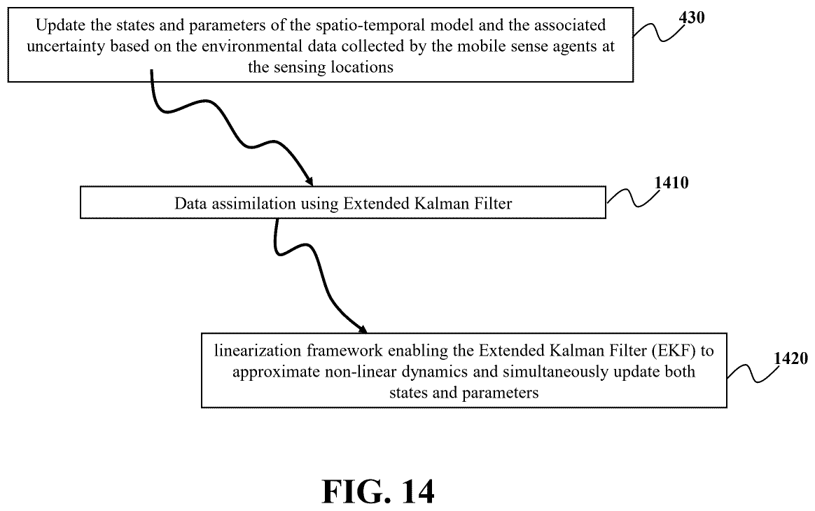

FIG. 14 illustrates a schematic of an embodiment of a system in which the states and parameters of the spatio-temporal model are updated 430 using an Extended Kalman Filter (EKF), which assimilates 1410 the environmental data collected by the mobile sensing agents at the sensing locations at different time steps, and uses a linearization framework enabling 1420 the Extended Kalman Filter (EKF) to approximate non-linear dynamics and simultaneously update both states and parameters.

In the embodiment illustrated in FIG. 14, the system employs an Extended Kalman Filter (EKF) to iteratively update the states and parameters of the spatio-temporal model representing bio-mass growth dynamics. This approach leverages environmental data collected by mobile sensing agents at various sensing locations over different time steps to enhance the accuracy and adaptability of the model. In this embodiment, the EKF uses linearization techniques to handle the non-linear dynamics of the spatio-temporal model. This linearization allows the EKF to approximate the non-linear process and measurement models for prediction and update of covariance matrices which represent uncertainties in the estimates, enabling it to update both the state and parameters iteratively and effectively.

The EKF operates within the framework of a state-space representation, combining a process model and a measurement model to describe the dynamics and observations of the system. The process model governs the temporal evolution of the state vector xₖ, which includes bio-mass density and related environmental variables, and is expressed as:

$${x}_{k + 1} = f ( {x}_{k} , {u}_{k} ; θ ) + {w}_{k} ,$$

where: xₖ represents the state vector at time step k, uₖ denotes external inputs such as temperature or nutrient levels, θ contains the model parameters (e.g., growth rates, diffusion coefficients), wₖ is the zero-mean Gaussian process noise with covariance matrix Qₖ.

The measurement model relates the observed environmental data to the system state through:

$${y}_{k} = h ( {x}_{k} ) + {v}_{k} ,$$

where: yₖ represents the measurement vector, h(xₖ) maps the state vector to observed measurements, vₖ is the zero-mean Gaussian measurement noise with covariance matrix Rₖ.

To facilitate the simultaneous estimation of both states and parameters, and an augmented state vector \tilde{x}ₖ is defined as follows:

$${\tilde{x}}_{k} = ( \begin{matrix}{x}_{k} \\ {θ}_{k}\end{matrix} )$$

Next, the models are expressed in terms of the augmented state vector as follows:

$${\tilde{x}}_{k + 1} = \tilde{f} ( {\tilde{x}}_{k} , {u}_{k} ) + {\tilde{w}}_{k}$$

$${y}_{k} = \tilde{h} ( {\tilde{x}}_{k} ) + {v}_{k}$$

$$Where ,$$

$$\tilde{f} ( {\tilde{x}}_{k} , {u}_{k} ) = ( \begin{matrix}f ( {x}_{k} , {u}_{k} ; {θ}_{k} ) \\ {θ}_{k}\end{matrix} )$$

$$\tilde{h} ( {\tilde{x}}_{k} ) = h ( {x}_{k} )$$

And \tilde{w}ₖ denotes an augmented zero-mean Gaussian process noise with covariance

$${\tilde{Q}}_{k} = ( \begin{matrix}{Q}_{k} & 0 \\ 0 & {Θ}_{k}\end{matrix} )$$

Where Θₖ denotes the covariance of the noise component associated with the parameters.

The EKF updates the states and parameters by alternating between prediction and update steps. During the prediction step, the filter projects the augmented state estimate and covariance forward in time using the augmented process model:

$${\tilde{x}}_{k + 1 \vert k} = \tilde{f} ( {\tilde{x}}_{k \vert k} , {u}_{k} )$$

$${\tilde{P}}_{k + 1 \vert k} = {\tilde{F}}_{k} {\tilde{P}}_{k \vert k} {\tilde{F}}_{k}^{T} + {\tilde{Q}}_{k} ,$$

where \tilde{x}_{k|k} and \tilde{P}_{k|k} respectively denote the posterior mean and covariance at time step k, obtained after assimilation of all measurements up to time step k. Similarly, \tilde{x}_{k+1|k} and \tilde{P}_{k+1|k} respectively denote the prior mean and covariance at time step k+1, predicted after assimilation of all measurements up to time step k. Further, \tilde{F}ₖ is Jacobian of \tilde{f} with respect to \tilde{x}ₖ, i.e.,

$${{\tilde{F}}_{k} = \frac{\partial \tilde{f}}{\partial \tilde{x}} \vert}_{\tilde{x} = {\tilde{x}}_{k \vert k}}$$

which captures the local linear approximation of the non-linear process model and is used to propagate the state covariance forward in time.

During the update step, the filter incorporates new measurements to refine the state and parameter estimates:

$${\tilde{K}}_{k} = {\tilde{P}}_{k \vert k - 1} {{\tilde{H}}_{k}^{T} ( {\tilde{H}}_{k} {\tilde{P}}_{k \vert k - 1} {\tilde{H}}_{k}^{T} + {R}_{k} )}^{- 1}$$

$${\tilde{P}}_{k \vert k} = ( I - {\tilde{K}}_{k} {\tilde{H}}_{k} ) {\tilde{P}}_{k \vert k - 1}$$

$${\tilde{x}}_{k \vert k} = {\tilde{x}}_{k \vert k - 1} + {\tilde{K}}_{k} ( {y}_{k} - \tilde{h} ( {\tilde{x}}_{k} ) )$$

where: \tilde{K}ₖ is the Kalman gain, I is the identity matrix, and \tilde{H}ₖ is the Jacobian of \tilde{h} with respect to \tilde{x}_{k|k-1}, i.e.,

$${{\tilde{H}}_{k} = \frac{\partial \tilde{h}}{\partial \tilde{x}} \vert}_{\tilde{x} = {\tilde{x}}_{k \vert k - 1}} .$$

which represents the linear approximation of the measurement model and is essential for integrating observed data into the filter.

By iteratively applying these steps, the EKF updates parameters such as growth rates and diffusion coefficients, ensuring that the model reflects real-time environmental dynamics. This continuous adaptation enables the system to accommodate changes in bio-mass growth patterns or external conditions, such as shifts in nutrient availability or temperature fluctuations.

The use of the Extended Kalman Filter (EKF) offers several distinct advantages that enhance the effectiveness of the spatio-temporal model. First, the EKF provides adaptability by dynamically incorporating new data into the model. This allows the system to continuously align with observed environmental changes, ensuring that its predictions remain relevant and responsive to evolving conditions. Second, the EKF demonstrates robustness to noise by effectively managing uncertainties in both the process model and the measurements. This capability ensures that states and parameter updates remain reliable, even when the data includes variations or inconsistencies due to environmental fluctuations or sensor limitations. Lastly, the EKF enhances predictive accuracy through its iterative refinement of model parameters. By continuously updating the parameters based on incoming data, the EKF supports improved reliability in the model's predictions. This ensures the system is well-equipped to provide accurate insights, facilitating effective monitoring and informed decision-making in dynamic environmental scenarios.

In practice, mobile sensing agents such as drones collect data on variables like bio-mass density, nutrient levels, and temperature at different locations and time steps. The EKF uses these measurements to update states and parameters in the spatio-temporal model, ensuring that the model remains accurate and responsive to dynamic environmental conditions.

In effect, the embodiment of FIG. 14 demonstrates how the EKF enables real-time parameter updates in the spatio-temporal model by assimilating data collected by mobile sensing agents. This approach enhances the model's accuracy and adaptability, ensuring it remains effective for dynamic environmental monitoring tasks. The linearization process allows the EKF to handle non-linear dynamics effectively. By approximating the behavior of non-linear functions around the current state estimate, the EKF maintains computational efficiency and ensures robust performance. This makes the EKF suitable for real-time applications where the system dynamics and observations may be non-linear but require accurate and adaptive modeling.

### Exemplar Implementation

### Problem Formulation

Consider a spatio-temporal environment, i.e., an environment where quantities of interest varies both in space and time. Denoting the spatial distribution of the quantities of interest by the vector xₖ, we model its temporal evolution,

$${x}_{k + 1} = f ( {x}_{k} , {u}_{k} ; θ ) + {w}_{k} , \qquad ( 1 )$$

where the evolution function ƒ(⋅) is parameterized by the parameter vector θ which may be unknown. uₖ denotes known external signals that affect the process evolution and Wₖ denotes additive zero mean Gaussian uncertainty of covariance Qₖ which may arise due to external disturbances or unmodeled process dynamics.

The process model (1) may arise as a result of spatio-temporal discretizations of partial differential equations (PDEs) or ordinary differential equations (ODEs) that describe the underlying process over continuous domains. This process model admits a broad class of spatio-temporal environmental processes including bio-mass growth in water bodies.

The monitoring of processes characterized by this model entails accurate dynamic estimation of the state vector xₖ and the parameters θ using limited sensor data. Assume the following measurement model.

$${y}_{k}^{\{ i \}} = {c}_{i}^{T} {x}_{k} + {η}_{k}^{\{ i \}} , \qquad ( 2 )$$

where

$${y}_{k}^{\{ i \}}$$

denotes the scalar measurement obtained from the i^{th} sensor and i∈ [symbol] , and the set [symbol] : ={1, 2, . . . [symbol] } of cardinality | [symbol] |= [symbol] denotes the set of all available sensors.

$${η}_{k}^{\{ i \}}$$

denotes the zero mean Gaussian noise with covariance

$${σ}_{i}^{2}$$

that corrupts the sensor measurement.

The sensor measurement model is assumed to be linear for the simplicity of discussion and the vectors cᵢ are assumed to be free of uncertainty as sensor measurement models are typically known. However, these assumptions can be readily relaxed.

Since xₖ denotes the process state variables discretized over a spatial grid, the elements of xₖ correspond to the process variables at different grid locations. Therefore, sensors in the set [symbol] may correspond to different locations where a measurement can be obtained. Since environmental processes are typically modeled over large geographical areas, the number of total available sensors or sensing locations in [symbol] can be very large. However, the number of obtainable measurements is often constrained by the limited resources, i.e., the availability of mobile agents (e.g., aerial drones) that travel to specific locations to obtain the measurements.

In general, identifying an optimal time-varying (sub)set of sensors (or sensing locations) that provides best monitoring or estimation performance over the entire monitoring duration is non-trivial because it is a combinatorial NP-hard problem.

Within this exemplar implementation, an agent is allowed to obtain a measurement from at most one sensing location at each time step. Further, each agent must be assigned a dynamically feasible sensing task at each time step to ensure full utilization of the available mobile agents. Therefore, in addition to optimizing the estimation performance, identifying a dynamically feasible assignment of agents to the sensing locations is an objective. Furthermore, agent assignments incur some assignment-costs, e.g., cost of travel from current location to the next assigned location. Therefore, it is also of interest to identify an agent-sensor assignment that incurs minimal travel costs. Finally, this problem of identifying the sensors and tasking the agents must be dynamically solved at every time step as the process evolves over time. To this end, some implementations consider the problem of dynamic sensor scheduling stated below:

Problem 1: Design a tractable, iterative algorithm that at time step, k, determines an optimal sensor subset [symbol] ₖ of cardinality M that: (i) minimizes the uncertainty in the estimates of xₖ and θ; (ii) yields a dynamically feasible assignment of agents to the identified sensing locations; and (iii) incurs a minimal travel cost.

where M is the number of mobile sensing agents.

### Data Assimilation Using EKF

Some implementations consider an extended Kalman filter (EKF) for assimilating sensor measurements and estimating the state vector xₖ and parameters θ. EKF employs the following form that is amenable for simultaneous state and parameter estimation:

$${\tilde{x}}_{k + 1} = [ \begin{matrix}{x}_{k + 1} \\ {θ}_{k + 1}\end{matrix} ] = [ \begin{matrix}f ( {x}_{k} , {u}_{k} ; {θ}_{k} ) \\ {θ}_{k}\end{matrix} ] + {\tilde{w}}_{k} = \tilde{f} ( {\tilde{x}}_{k} , {u}_{k} ) + {\tilde{w}}_{k} \qquad ( 3 )$$

$${y}_{k}^{\{ i \}} = {\tilde{c}}_{i}^{T} {\tilde{x}}_{k} + {η}_{k}^{\{ i \}} , \qquad ( 4 )$$

where

$${\tilde{x}}_{k} := {[ \begin{matrix}{x}_{k}^{T} & {θ}_{k}^{T}\end{matrix} ]}^{T}$$

is the augmented state vector to be estimated, \tilde{w}ₖ denotes the augmented zero-mean Gaussian process uncertainty with block-diagonal covariance matrix \tilde{Q}ₖ:

$${\tilde{Q}}_{k} = ( \begin{matrix}{Q}_{k} & 0 \\ 0 & {Θ}_{k}\end{matrix} )$$

The noise covariance Θₖ corresponding to the parameters is typically assigned a small value. Furthermore, the sensor measurement model is updated to account for additional states in the augmented state vector, i.e,

$${\tilde{c}}_{i} = {[ \begin{matrix}{c}_{i}^{T} & {0}_{{n}_{θ}}^{T}\end{matrix} ]}^{T} ,$$

where O_{nθ} denotes a zero vector in n_{θ}-dimensions.

The posterior and prior distributions of the state estimate at time k are assumed to be Gaussian and characterized by the mean-covariance pairs (\tilde{x}_{k|k}, \tilde{P}_{k|k}) and (\tilde{x}_{k|k-1}, \tilde{P}_{k|k-1}) respectively. The EKF equations to estimate the augmented vector \tilde{x}ₖ are presented next.

Using the augmented model, the equations corresponding to the prediction or time-update step of EKF are given as follows:

$${\tilde{x}}_{k + 1 \vert k} = \tilde{f} ( {\tilde{x}}_{k \vert k} , {u}_{k} ) \qquad ( 5 )$$

$${\tilde{P}}_{k + 1 \vert k} = {\tilde{F}}_{k} {\tilde{P}}_{k \vert k} {\tilde{F}}_{k}^{T} + {\tilde{Q}}_{k} \qquad ( 6 )$$

$$where$$

$${\tilde{F}}_{k} := \frac{\partial \tilde{f}}{\partial \tilde{x}} ( {\tilde{x}}_{k} , {u}_{k} ) = [ \begin{matrix}\frac{\partial f}{\partial x} ( {x}_{k} , {u}_{k} ; {θ}_{k} ) & \frac{\partial f}{\partial θ} ( {x}_{k} , {u}_{k} ; {θ}_{k} ) \\ 0 & I\end{matrix} ] \qquad ( 7 )$$

and I denotes an identity matrix of the suitable dimension.

Given the prior estimates, the posterior estimate is obtained by the following measurement update step of the EKF

$${\tilde{K}}_{k} = {\tilde{P}}_{k \vert k - 1} {{\tilde{H}}_{k}^{T} ( {\tilde{H}}_{k} {\tilde{P}}_{k \vert k - 1} {\tilde{H}}_{k}^{T} + {R}_{k} )}^{- 1} \qquad ( 8 )$$

$${\tilde{P}}_{k \vert k} = ( I - {\tilde{K}}_{k} {\tilde{H}}_{k} ) {\tilde{P}}_{k \vert k - 1} \qquad ( 9 )$$

$${\tilde{x}}_{k \vert k} = {\tilde{x}}_{k \vert k - 1} + {\tilde{K}}_{k} ( {y}_{k} - \tilde{h} ( {\tilde{x}}_{k} ) ) \qquad ( 10 )$$

$$where$$

$${\tilde{H}}_{k} = {[ \begin{matrix}{c}_{{i}_{1}} & {c}_{{i}_{2}} & ⋯ & \\ 0 & 0 & ⋯ & \end{matrix} ]}^{T} \qquad ( 11 )$$

is the measurement matrix corresponding to the set of selected sensors [symbol] ={i₁, i₂, . . . i_{M}}⊆ [symbol] at time step k.

### Estimation Quality

In order to solve Problem 1, there is a need for a scalar measure of the uncertainty in the estimate \tilde{x}ₖ. An example of a measure is the volume of the confidence ellipsoid around the mean. Accordingly, some implementations quantify the uncertainty in the estimate of \tilde{x}ₖ by the log-determinant of the posterior covariance of \tilde{P}_{k|k}, i.e., logdet(\tilde{P}_{k|k}) which is a function of the selected sensor measurements [symbol] ₖ at time step k. Therefore, some implementations define the objective function for the estimation quality in terms of selected sensors

$${J}_{est} ( {𝒮}_{k} ) = log det ( {\tilde{P}}_{k \vert k} ) , \qquad ( 12 )$$

which is minimized.

### Dynamical Constraints and Cost of Travel

Some implementations ensure that the sensor schedule generated is feasible for the mobile agents team. Specifically, these implementations restrict the possible sensing locations to only those that are reachable from the current agent locations. In other words, these reachability constraints enforce physical constraints arising from dynamics of the mobile agents.

For a grid world, given the current agents team location, some implementations can compute the set of locations reachable by the team with a pre-specified number of steps Nₛₜₑₚₛ using any of the existing shortest path algorithms. Here, lower Nₛₜₑₚₛ facilitates more frequent measurements, while larger Nₛₜₑₚₛ allows for broader coverage of the environment. As a side-product, some implementations also obtain Dᵢⱼ, the shortest distance between the mobile agent i's current location and a candidate sensor location j in the grid.

Some implementations assume that the locations or grid-cells that are within Nₛₜₑₚₛ steps from the current location of an agent are reachable, where moving to an adjacent cell counts as one step and moving to a diagonal location is not allowed.

Thus, for a given location of the i^{th} mobile agent, we can identify [symbol] ᵢ—the coverage set of the i^{th} agent, i.e., the set of all sensors that are reachable from its current location. In particular,

$${𝒞}_{i} := \{ j \vert j ∈ 𝒮 , {D}_{ij} \leq {N}_{steps} \} . \qquad ( 13 )$$

Assignment of i^{th} agent to the sensing location j∈ [symbol] is denoted by an ordered tuple (i, j). A dynamically feasible assignment is defined as follows.

### Definition 1 an Assignment Set

$${𝒜}_{k} := \{ ( i , {j}_{i} ) \vert {j}_{i} ∈ 𝒮 , i = 1 , 2 , ⋯ M \} \qquad ( 14 )$$

is said to be dynamically feasible if jᵢ ∈ [symbol] ᵢ ∀i∈{1, 2, . . . M}, and jᵢ_{₁}≠jᵢ_{₂} ∀ᵢ_{₁}, i₂ ∈{1, 2, . . . M}.

The definition essentially enforces the constraint that every agent gets assigned a sensor that lies in its coverage set, and no two agents get assigned the same sensor location.

The cost of travel for the assignment (i, j) is simply Dᵢⱼ. Therefore, the total cost of travel for an assignment set [symbol] ₖ is given by

$${J}_{travel} ( {𝒜}_{k} ) = {\sum }_{i} {D}_{{ij}_{i}} \qquad ( 15 )$$

which is minimized.

Some implementations make the following assumptions—(i) the sensor scheduling need not account for collision avoidance between agents, and (ii) there are no obstacles/no-fly zones in the environment. The first assumption may be relaxed in other implementations by considering multi-agent motion planners at the cost of increased computational effort. While second assumption simplifies the implementation, it can be easily relaxed by appropriately defining coverage sets for the agents.

Considering Problem 1, and the objectives Jₑₛₜ and Jₜᵣₐᵥₑₗ, the bi-criterion optimization problem is stated as follows

$${min}_{{𝒜}_{k}} [ \begin{matrix}{J}_{est} \\ {J}_{travel}\end{matrix} ] \qquad ( 16 )$$

subject to [symbol] ₖ being dynamically feasible.

The set of selected sensor [symbol] k is already a part of [symbol] ₖ, hence, it is not written as an explicit optimization variable in the optimization formulation above.

This is a vector optimization which can not be directly solved. A standard approach to solve such problems is to scalarize the objective function. However, such an approach may not be tractable in this case as [symbol] ₖ is a combinatorial variable. Instead, a greedy algorithm is implemented for simultaneous sensor selection and agent assignment which yields a feasible solution to the optimization problem in polynomial time.

### Minimizing Jₑₛₜ

In some implementations, minimization of Jₑₛₜ is equivalently expressed as maximization of

$${J}_{est}^{′} ( {𝒮}_{k} ) , i . e . ,$$

$$arg {min}_{{𝒮}_{k} , \vert {𝒮}_{k} \vert = M} {J}_{est} ( {𝒮}_{k} ) = arg {max}_{{𝒮}_{k} , \vert {𝒮}_{k} \vert = M} {J}_{est}^{′} ( {𝒮}_{k} ) \qquad ( 17 )$$

$$where$$

$${J}_{est}^{′} ( {𝒮}_{k} ) := logdet ( {( {\tilde{P}}_{k \vert k} )}^{- 1} ) \qquad ( 18 )$$

$$= logdet ( {( {\tilde{P}}_{k \vert k} )}^{- 1} + {\sum }_{i ∈ {𝒮}_{k}} {σ}_{i}^{- 2} {\tilde{c}}_{i} {\tilde{c}}_{i}^{⊤} ) \qquad ( 19 )$$

which follows from the information form of Kalman update, and

$${σ}_{i}^{- 2} {\tilde{c}}_{i} {\tilde{c}}_{i}^{⊤}$$

denotes the information matrix of the sensor i∈ [symbol] ₖ.

The function

$${J}_{est}^{′} : {2}^{𝒮} ↦ ℝ$$

is a submodular monotonic function ∀ [symbol] _k⊆ [symbol] .

Consequently, the maximization of

$${J}_{est}^{′}$$

corresponds to the maximization of monotonic submodular function. Therefore, a greedy methods are guaranteed to yield a solution that is within a factor of (1−1/e) of the optimal solution based on well-established guarantees in the literature.

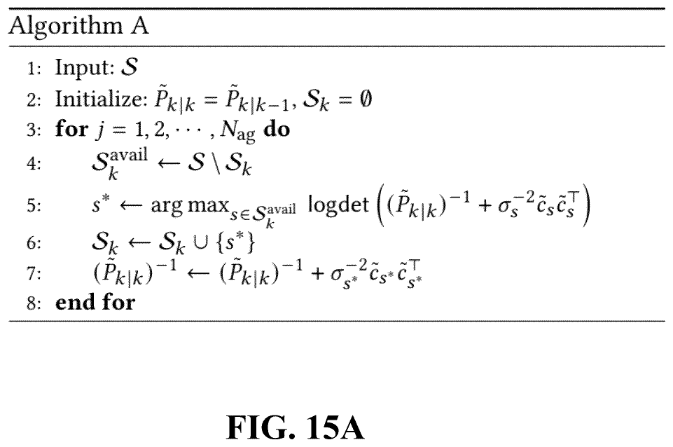

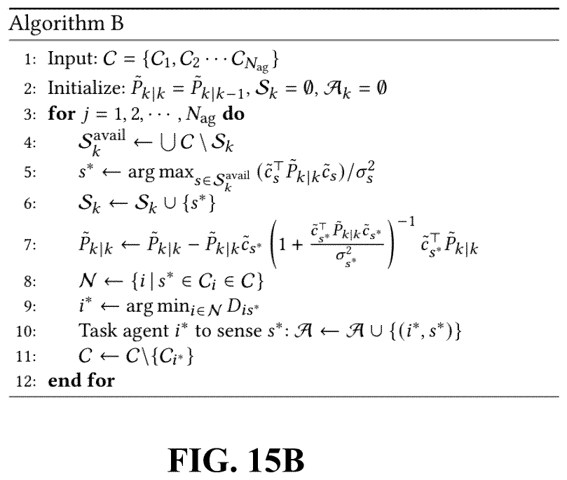

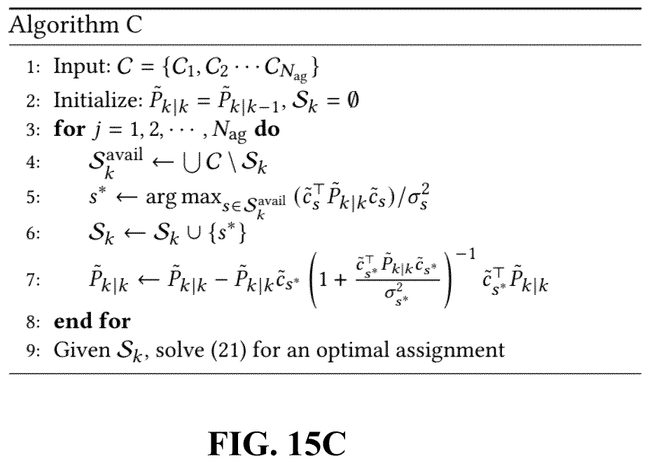

FIG. 15A shows a pseudo-code of an algorithm used by some embodiments. For example, one embodiment Some implementations may use a greedy approach in the Algorithm A for maximization of

$${J}_{est}^{′} .$$

In each iteration of the greedy algorithm, a sensor is selected that results in in the largest increment in the objective

$${J}_{est}^{′} .$$

This is effectively implemented by updating the covariance matrix in the last line of the algorithm for every selected sensor which utilizes the sequential measurements assimilation of the Kalman update for a simplified evaluation of objective increments in Step 5.

However, a classical greedy Algorithm A which solves (17) does not assign agents, ignores the cost of travel, Jₜᵣₐᵥₑₗ, and may lead to unnecessarily higher cost of travel for the mobile agents.

Some implementations use an improved greedy algorithm that simultaneously select sensing locations and assign agents while minimizing cost of travel.

### Simultaneous Greedy Sensor Selection and Agent Assignment

FIGS. 15A, 15B, and 15C show pseudo-codes of different algorithms used by various embodiments. For example, FIG. 15A shows a pseudo-code of an algorithm used by some embodiments. Some implementations solve (16). A greedy selection of [symbol] ₖ to maximize the objective function Jₑₛₜ′ entails, in each iteration, selection of one sensor that results in the largest increment in the objective function, until M sensors have been selected. Heuristics incorporated in Algorithm B aim to minimize the travel cost while guaranteeing that the selected sensor set yields a dynamically feasible assignment of agents and the sensors.

The input to Algorithm B is the coverage sets of all agents at the current time step and it runs for M iterations to select one sensor in each iteration. The set of available sensors to choose from,

$${𝒮}_{k}^{avail} ,$$

is determined to be all sensors in ∪ [symbol] except [symbol] ₖ—the sensors already selected in the previous iterations of the algorithm. This ensures that no sensor gets selected more than once.

In lines 5-7 of the algorithm, a sensor is selected that yields the maximum increment in the objective value, and ties, if any, are settled arbitrarily; and the covariance matrix is updated for the selected sensor.

In lines 8-11 of the algorithm, the selected sensor is assigned to one of the nearest agents that is currently un-tasked and reachable from the selected sensor. Note that D_{is*} denotes the distance of i^{th} agent from the sensor s*, and the objective is to minimize the travel cost incurred by the mobile agent. The coverage set of the assigned agent is removed from [symbol] in line 11 to ensure that each agent gets assigned exactly one sensor.

Steps 5-7 of Algorithms A and B are mathematically equivalent. Using matrix determinant lemma,

$$det ( {( {\tilde{P}}_{k \vert k} )}^{- 1} + {σ}_{i}^{- 2} {\tilde{c}}_{i} {\tilde{c}}_{i}^{⊤} ) = ( 1 + \frac{{\tilde{c}}_{i}^{⊤} {\tilde{P}}_{k \vert k} {\tilde{c}}_{i}}{{σ}_{i}^{2}} ) det ( {( {\tilde{P}}_{k \vert k} )}^{- 1} ) , \qquad ( 20 )$$

the Step 5 of Algorithm A can be equivalently reduced to Step 5 of Algorithm B. Similarly, Step 7 of Algorithm A can be equivalently written in standard covariance update form shown in Step 7 of Algorithm B. Some implementations utilize these equivalent substitutions to reduce the overall computational time complexity of the algorithm. Algorithm B has the worst-case time complexity of

$$𝒪 ( M {{n}_{𝒞} ( {n}_{x} + {n}_{θ} )}^{2} + {n}_{𝒞} {M}^{3} ) ,$$

where [symbol] :=|∪ [symbol] |.

The heuristics incorporated in Algorithm B to satisfy the dynamic feasibility of assignment mean that its optimality guarantees are not theoretically provable.

Some implementations use the following algorithm which offers some performance guarantees under certain scenarios.

### Common Coverage Sets

FIG. 15A shows a pseudo-code of an algorithm used by some embodiments. In some scenario, coverage sets could be identical for all agents, i.e., [symbol] ₁= [symbol] ₂= . . . = [symbol] _{M}. Such a scenario may arise when all agents are in proximity of each other or when allowable Nₛₜₑₚₛ used in identifying reachable sets is sufficiently large to cover all candidate sensor locations.

Under these conditions, some implementations decouple the problem of sensor selection from agent assignment since any set [symbol] ₖ ⊆ of cardinality M will result in a dynamically feasible assignment. In such a case, some implementations adopt a two-step approach summarized in Algorithm C.

Such an implementations first greedily select sensors by ignoring the assignment Steps 8-11 of the Algorithm B. Subsequently, a linear assignment problem is solved to assign the selected sensor locations to individual agents to minimize the total cost of travel. Linear assignment problems are a special class of integer linear programs, that admit polynomial time solutions.

Consider the scenario of mobile agents that must be assigned M selected sensing locations. An assignment problem is formulated as follows:

$$minimize {\sum }_{1 \leq i \leq M , 1 \leq j \leq M} {D}_{ij} {Z}_{ij} \qquad ( 21 )$$

$$subject to Z ∈ {\{ 0 , 1 \}}^{M \times M} ,$$

$${1}_{1 \times M} Z \leq 1 , Z {1}_{M \times 1} \leq 1 .$$

Specifically, given a collection of costs D∈ [symbol] ^{M×M} where Dᵢⱼ is the shortest distance between the i^{th} agent and the j^{th} selected sensor location, the linear assignment problem seeks to identify an assignment Z where Zᵢⱼ=1 implies that mobile agent i is assigned to the sensing location j, and the constraints 1_{1xM}Z≤1, Z1_{M×1}≤1 ensures that each sensing location is assigned at most one mobile agent and each mobile agent is assigned at most one sensing location, respectively.

Steps 3-8 of the Algorithm C is the greedy approach to maximize a monotonic submodular function, therefore, it is guaranteed to yield a solution that is within a factor of (1−1/e) of the optimal solution. Problem (21) can be solved exactly in polynomial time. Algorithm C has the worst-case time complexity of

$$𝒪 ( M {{n}_{𝒞} ( {n}_{x} + {n}_{θ} )}^{2} + {n}_{𝒞} {M}^{3} ) ,$$

where [symbol] :=|∪ [symbol] |.

Some implementations consider the following dynamical model for bio-mass (e.g., algae) growth in water bodies,

$$\dot{x} ( t ) = a \frac{u ( t ) - x ( t )}{u ( t )} x ( t ) + {\sum }_{i = 1}^{2} {b}_{i} \frac{{\partial }^{2} x ( t )}{\partial {z}_{i}^{2}} . \qquad ( 22 )$$

where x(t) denotes the bio-mass density at an arbitrary location, a, bᵢ are uncertain parameters, u(t) is a known signal that accounts for effects due to external disturbances, and zᵢ is the i^{th} spatial dimension.

Although it is a simplified representation of bio-mass growth in water bodies, it captures fundamental characteristics of bio-mass growth. The rate of change of bio-mass density is a spatio-temporal function of the current density. The first term on right hand side of (22) resembles the logistic population growth whose carrying capacity is limited by u(t). The carrying capacity or the maximum sustainable bio-mass density in water bodies is affected by many external factors including available amount of nutrients, ambient lighting conditions and temperatures, amount of precipitation, etc. In favor of a simple model and computational efficiency, some implementations lump these external effects into the signal u(t) which is assumed to be known.

The second term in (22) accounts for the diffusion of bio-mass from high-density locations to low-density locations. Some implementations assume a case in which the density varies over two-dimensional spatial domain (e.g., the water surface). Some implementations may account for the third spatial dimension as well as effects of gravity on diffusion of mass density.

Some implementations discretize the continuous partial differential equation (22) over a uniformly spaced two-dimensional G×G grid or cells-matrix. The columns of this cells-matrix are stacked resulting in a discretized state vector, xₖ, whose elements correspond to densities in different cells and its evolution can be written in the form (1). The diffusion terms i.e. the second derivatives are discretized and approximated using finite differences.

In some implementations, the set of all available sensing locations, [symbol] , corresponds to the all-possible locations or grid cells where bio-mass density can be measured. Thus, there are total | [symbol] |=G² sensing locations. In (2), cᵢ is a standard basis vector whose i^{th} element is unity. In other words, the i^{th} sensor measures bio-mass density at the cell corresponding to i^{th} element of xₖ. Mobile agents are assumed to be equipped with onboard instrumentation to measure densities and transmit the measurement data to a centralized planner.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, and any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship with each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A system for dynamic monitoring of spatio-temporal environmental processes describing bio-mass growth in water bodies using a plurality of mobile sensing agents equipped with sensors for collecting environmental data, the system comprising: a processor; and a memory having instructions stored thereon that, when executed by the processor, cause the system to:
implement a spatio-temporal model representing dynamic behaviors of the environmental processes based on parameters of the spatio-temporal model to predict a state of the bio-mass growth in water bodies defined by environmental variables, and an associated uncertainty;
execute a scheduling algorithm configured to select sensing locations for the mobile sensing agents and assign the mobile sensing agents to the selected sensing locations by optimizing an objective function of the state of the bio-mass growth and the associated uncertainty subject to operational constraints and reachability limitations of the mobile sensing agents;
update the states and parameters of the spatio-temporal model based on the environmental data collected by the mobile sensing agents at the sensing locations; and
generate subsequent sensing location selections and agent assignments using the updated spatio-temporal model.

2. The system of claim 1, wherein the spatio-temporal model represents bio-mass growth dynamics using a reaction-diffusion framework, incorporating logistic growth terms, diffusion coefficients, and external forcing terms to describe spatio-temporal variations in density of the bio-mass.

3. The system of claim 1, wherein the scheduling algorithm employs a greedy approach to simultaneously select sensing locations and assign mobile sensing agents, minimizing travel costs while ensuring a dynamically feasible assignment.

4. The system of claim 1, wherein the scheduling algorithm optimizes an objective function defined as a log-determinant of a posterior covariance matrix of the state of the bio-mass growth to reduce the associated uncertainty in the predictions from the spatio-temporal model.

5. The system of claim 1, wherein the parameters of the spatio-temporal model include growth rates, nutrient uptake rates, and diffusion coefficients, which are updated iteratively based on environmental data collected by the mobile sensing agents.

6. The system of claim 1, wherein the scheduling algorithm incorporates reachability constraints by limiting sensing location selections to those accessible within a predefined distance or number of steps from locations of the mobile sensing agents.

7. The system of claim 1, wherein the scheduling algorithm optimizes the objective function that balances multiple objectives by assigning weighted values to uncertainty reduction, travel cost minimization, and dynamic feasibility, and determines sensing locations and mobile sensing agent assignments based on the weighted combination of the multiple objectives.

8. The system of claim 1, wherein the scheduling algorithm uses heuristics to prioritize sensing locations that provide the largest favorable change in the objective function while ensuring dynamic feasibility.

9. The system of claim 1, wherein the scheduling algorithm ensures that each mobile sensing agent is assigned to one sensing location per time step, avoiding duplicate assignments and ensuring full utilization of available agents.

10. The system of claim 1, wherein the spatio-temporal model is implemented using discretized partial differential equations to represent the bio-mass growth over a spatial grid.

11. The system of claim 1, wherein the spatio-temporal model accounts for external factors influencing bio-mass growth, including one or a combination of temperature, nutrient availability, and water currents, through the integration of external forcing terms.

12. The system of claim 1, wherein the parameters of the spatio-temporal model are updated using an Extended Kalman Filter (EKF), which assimilates the environmental data collected by the mobile sensing agents at the sensing locations at different time steps.

13. The system of claim 12, wherein the spatio-temporal model includes a process model predicting the evolution of environmental variables and parameters with process noise, a measurement model relating observations to the state vector with measurement noise, and a linearization framework enabling the Extended Kalman Filter (EKF) to approximate non-linear dynamics and simultaneously update both states and parameters of the spatio-temporal model.

14. The system of claim 1, wherein the system incorporates pre-determined operational constraints, including limits on the maximum travel distance, battery life, and sensing range of the mobile sensing agents.

15. The system of claim 1, wherein the mobile sensing agents are configured to travel to the assigned sensing locations, collect measurements data, and transmit the data to a centralized processor for assimilation into the spatio-temporal model.

16. The system of claim 1, wherein the mobile sensing agents are aerial drones.

17. A method for dynamic monitoring of spatio-temporal environmental processes describing bio-mass growth in water bodies using a plurality of mobile sensing agents equipped with sensors for collecting environmental data, wherein the method uses a processor coupled with stored instructions implementing the method, wherein the instructions, when executed by the processor carry out steps of the method, comprising:
implementing a spatio-temporal model representing dynamic behaviors of the environmental processes based on parameters of the spatio-temporal model to predict a state of the bio-mass growth in water bodies defined by environmental variables, and the associated uncertainty;
executing a scheduling algorithm configured to select sensing locations for the mobile sensing agents and assign the mobile sensing agents to the selected sensing locations by optimizing an objective function of the state of the bio-mass growth and the associated uncertainty subject to operational constraints and reachability limitations of the mobile sensing agents;
updating the states and parameters of the spatio-temporal model based on the environmental data collected by the mobile sensing agents at the sensing locations; and
generating subsequent sensing location selections and agent assignments using the updated spatio-temporal model.

18. The method of claim 17, further comprising:
implementing a greedy optimization algorithm to iteratively select sensing locations that maximize information gain and assign mobile sensing agents to those locations, while minimizing travel costs and ensuring operational feasibility.

19. The method of claim 17, further comprising:
updating the spatio-temporal model using data assimilation techniques, including applying an Extended Kalman Filter (EKF) to refine both the states and parameters of the model, wherein the EKF linearizes the model to approximate non-linear dynamics and incorporates collected data into the model.

20. The method of claim 17, further comprising:
operating the mobile sensing agents as unmanned aerial vehicles (UAVs) equipped with: sensors to measure bio-mass density, nutrient levels, and temperature profiles; a communication module to transmit collected data to a control system; and a flight control mechanism to navigate dynamically to assigned sensing locations based on the optimization of data collection efforts.
